(19) United States
(12) Patent Application Publication
(10) Pub. No.: US 2026/0006597 A1
(43) Pub. Date: Jan. 1, 2026

(54) SYNCHRONIZATION SIGNAL BLOCK AND REMAINING SYSTEM INFORMATION MULTIPLEXING PATTERNS

(71) Applicant: QUALCOMM Incorporated, San Diego, CA (US)

(72) Inventors: Kiran VENUGOPAL, Green Brook, NJ (US); Yan ZHOU, San Diego, CA (US); Yongle WU, San Diego, CA (US); Yong LI, San Diego, CA (US); Raghu Narayan CHALLA, San Diego, CA (US)

(21) Appl. No.: 18/755,250

(22) Filed: Jun. 26, 2024

(51) Int. Cl. H04W 72/044; H04W 56/00; H04W 72/1273

(52) U.S. Cl. CPC H04W 72/046; H04W 56/0015; H04W 72/1273

(57) ABSTRACT

Methods, systems, and devices for wireless communications are described. A user equipment (UE) may monitor for synchronization signal blocks (SSBs) from a cell to perform an initial cell search. The UE may use the primary synchronization signal (PSS) and secondary synchronization signal (SSS) of an SSB to synchronize timing with the cell and to decode the physical broadcast channel (PBCH) of the SSB, which may include system information (SI) for the cell and may include scheduling information for a physical downlink control channel (PDCCH) occasion for the UE to monitor for additional SI. The PDCCH and the PDSCH which convey additional SI may be multiplexed with the PSS, SSS, and/or PBCH, where at least the PSS is disjoint from the corresponding PBCH. For example, the PSS may be disjoint from the PBCH, and the PDSCH may be received during the same symbols as the PBCH and/or the SSS.

### FIELD OF TECHNOLOGY

The following relates to wireless communications, including synchronization signal block and remaining system information multiplexing patterns.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, via a beam and during a first symbol, a primary synchronization signal (PSS) and receiving, via the beam and during a second set of symbols subsequent to the first symbol, a physical broadcast channel (PBCH) transmission and a physical downlink shared channel (PDSCH) transmission, where the second set of symbols is disjoint in time with the first symbol, and where the PDSCH transmission conveys a system information (SI) message.

A UE for wireless communications is described. The UE may include one or more memories storing processor executable code, and one or more processors coupled with the one or more memories. The one or more processors may individually or collectively be operable to execute the code to cause the UE to receive, via a beam and during a first symbol, a PSS and receive, via the beam and during a second set of symbols subsequent to the first symbol, a PBCH transmission and a PDSCH transmission, where the second set of symbols is disjoint in time with the first symbol, and where the PDSCH transmission conveys an SI message.

Another UE for wireless communications is described. The UE may include means for receiving, via a beam and during a first symbol, a PSS and means for receiving, via the beam and during a second set of symbols subsequent to the first symbol, a PBCH transmission and a PDSCH transmission, where the second set of symbols is disjoint in time with the first symbol, and where the PDSCH transmission conveys an SI message.

A non-transitory computer-readable medium storing code for wireless communications is described. The code may include instructions executable by one or more processors to receive, via a beam and during a first symbol, a PSS and receive, via the beam and during a second set of symbols subsequent to the first symbol, a PBCH transmission and a PDSCH transmission, where the second set of symbols is disjoint in time with the first symbol, and where the PDSCH transmission conveys an SI message.

Some examples of the method, UEs, and non-transitory computer-readable medium described herein may further include operations, features, means, or instructions for receiving, via the beam and during the second set of symbols, a secondary synchronization signal (SSS), where the SSS in combination with the PSS may be indicative of a cell identifier associated with the PBCH transmission.

Some examples of the method, UEs, and non-transitory computer-readable medium described herein may further include operations, features, means, or instructions for receiving, via the beam and during the first symbol, a first physical downlink control channel (PDCCH) transmission and receiving, via the beam and during a second symbol, a second PDCCH transmission, where the second symbol may be one of the second set of symbols, where at least one of the first PDCCH transmission or the second PDCCH transmission indicates scheduling information for the PDSCH transmission.

In some examples of the method, UEs, and non-transitory computer-readable medium described herein, receiving the PBCH transmission may include operations, features, means, or instructions for receiving the PBCH transmission including a master information block (MIB), where the MIB indicates that the first symbol conveys the first PDCCH transmission and the second symbol conveys the second PDCCH transmission.

In some examples of the method, UEs, and non-transitory computer-readable medium described herein, jointly decoding, based on the MIB, the first PDCCH transmission and the second PDCCH transmission to identify the scheduling information for the PDSCH transmission.

Some examples of the method, UEs, and non-transitory computer-readable medium described herein may further include operations, features, means, or instructions for receiving, via the beam and during two symbols of the second set of symbols, a PDCCH transmission that indicates scheduling information for the PDSCH transmission.

In some examples of the method, UEs, and non-transitory computer-readable medium described herein, receiving the PBCH transmission may include operations, features, means, or instructions for receiving the PBCH transmission including a MIB, where the MIB indicates that the two symbols convey the PDCCH transmission.

Some examples of the method, UEs, and non-transitory computer-readable medium described herein may further include operations, features, means, or instructions for receiving, via the beam and during a second symbol consecutive with the first symbol, an SSS, where the SSS in combination with the PSS may be indicative of a cell identifier associated with the PBCH transmission.

Some examples of the method, UEs, and non-transitory computer-readable medium described herein may further include operations, features, means, or instructions for receiving, via the beam and during the first symbol and the second symbol, a PDCCH transmission that indicates scheduling information for the PDSCH transmission.

In some examples of the method, UEs, and non-transitory computer-readable medium described herein, the second set of symbols includes two symbols, the PBCH transmission and the PDSCH transmission may be frequency division multiplexed on the two symbols, and the PDCCH transmission may be frequency division multiplexed with the PSS on the first symbol and the SSS on the second symbol.

In some examples of the method, UEs, and non-transitory computer-readable medium described herein, receiving the PBCH transmission may include operations, features, means, or instructions for receiving the PBCH transmission including a MIB, where the MIB indicates that the first symbol and the second symbol convey the PDCCH transmission.

Some examples of the method, UEs, and non-transitory computer-readable medium described herein may further include operations, features, means, or instructions for receiving a set of multiple PSSs via a set of multiple respective beams and during a set of multiple respective first symbols, where the set of multiple PSSs includes the PSS, where the set of multiple respective beams includes the beam, and where the set of multiple respective first symbols includes the first symbol and receiving a set of multiple PBCH transmissions and a set of multiple PDSCH transmissions via the set of multiple respective beams and during a set of multiple respective second sets of symbols, where the set of multiple respective second sets of symbols may be disjoint in time with the set of multiple respective first symbols, and where the set of multiple PDSCH transmissions convey respective SI messages.

A method for wireless communications by a network entity is described. The method may include outputting, via a beam and during a first symbol, a PSS and outputting, via the beam and during a second set of symbols subsequent to the first symbol, a PBCH transmission and a PDSCH transmission, where the second set of symbols is disjoint in time with the first symbol, and where the PDSCH transmission conveys an SI message.

A network entity for wireless communications is described. The network entity may include one or more memories storing processor executable code, and one or more processors coupled with the one or more memories. The one or more processors may individually or collectively be operable to execute the code to cause the network entity to output, via a beam and during a first symbol, a PSS and output, via the beam and during a second set of symbols subsequent to the first symbol, a PBCH transmission and a PDSCH transmission, where the second set of symbols is disjoint in time with the first symbol, and where the PDSCH transmission conveys an SI message.

Another network entity for wireless communications is described. The network entity may include means for outputting, via a beam and during a first symbol, a PSS and means for outputting, via the beam and during a second set of symbols subsequent to the first symbol, a PBCH transmission and a PDSCH transmission, where the second set of symbols is disjoint in time with the first symbol, and where the PDSCH transmission conveys an SI message.

A non-transitory computer-readable medium storing code for wireless communications is described. The code may include instructions executable by one or more processors to output, via a beam and during a first symbol, a PSS and output, via the beam and during a second set of symbols subsequent to the first symbol, a PBCH transmission and a PDSCH transmission, where the second set of symbols is disjoint in time with the first symbol, and where the PDSCH transmission conveys an SI message.

Some examples of the method, network entities, and non-transitory computer-readable medium described herein may further include operations, features, means, or instructions for outputting, via the beam and during the second set of symbols, an SSS, where the SSS in combination with the PSS may be indicative of a cell identifier associated with the PBCH transmission.

Some examples of the method, network entities, and non-transitory computer-readable medium described herein may further include operations, features, means, or instructions for outputting, via the beam and during the first symbol, a first PDCCH transmission and outputting, via the beam and during second symbol, a second PDCCH transmission, where the second symbol may be one of the second set of symbols, where at least one of the first PDCCH transmission or the second PDCCH transmission indicates scheduling information for the PDSCH transmission.

In some examples of the method, network entities, and non-transitory computer-readable medium described herein, outputting the PBCH transmission may include operations, features, means, or instructions for outputting the PBCH transmission including a MIB, where the MIB indicates that the first symbol conveys the first PDCCH transmission and the second symbol conveys the second PDCCH transmission.

Some examples of the method, network entities, and non-transitory computer-readable medium described herein may further include operations, features, means, or instructions for outputting, via the beam and during two symbols of the second set of symbols, a PDCCH transmission that indicates scheduling information for the PDSCH transmission.

In some examples of the method, network entities, and non-transitory computer-readable medium described herein, outputting the PBCH transmission may include operations, features, means, or instructions for outputting the PBCH transmission including a MIB, where the MIB indicates that the two symbols convey the PDCCH transmission.

Some examples of the method, network entities, and non-transitory computer-readable medium described herein may further include operations, features, means, or instructions for outputting, via the beam and during a second symbol consecutive with the first symbol, an SSS, where the SSS in combination with the PSS may be indicative of a cell identifier associated with the PBCH transmission.

Some examples of the method, network entities, and non-transitory computer-readable medium described herein may further include operations, features, means, or instructions for outputting, via the beam and during the first symbol and the second symbol, a PDCCH transmission that indicates scheduling information for the PDSCH transmission.

In some examples of the method, network entities, and non-transitory computer-readable medium described herein, the second set of symbols includes two symbols, the PBCH transmission and the PDSCH transmission may be frequency division multiplexed on the two symbols, and the PDCCH transmission may be frequency division multiplexed with the PSS on the first symbol and the SSS on the second symbol.

In some examples of the method, network entities, and non-transitory computer-readable medium described herein, outputting the PBCH transmission may include operations, features, means, or instructions for outputting the PBCH transmission including a MIB, where the MIB indicates that the first symbol and the second symbol convey the PDCCH transmission.

Some examples of the method, network entities, and non-transitory computer-readable medium described herein may further include operations, features, means, or instructions for outputting a set of multiple PSSs via a set of multiple respective beams and during a set of multiple respective first symbols, where the set of multiple PSSs includes the PSS, where the set of multiple respective beams includes the beam, and where the set of multiple respective first symbols includes the first symbol and outputting a set of multiple PBCH transmissions and a set of multiple PDSCH transmissions via the set of multiple respective beams and during a set of multiple respective second sets of symbols, where the set of multiple respective second sets of symbols may be disjoint in time with the set of multiple respective first symbols, and where the set of multiple PDSCH transmissions convey respective SI messages.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports synchronization signal block (SSB) and remaining system information (SI) multiplexing patterns in accordance with one or more aspects of the present disclosure.

FIG. 2 shows an example of an SSB resource diagram that supports SSB and remaining SI multiplexing patterns in accordance with one or more aspects of the present disclosure.

FIG. 3 shows examples of synchronization signal (SS) and SSB resource diagrams that supports SSB and remaining SI multiplexing patterns in accordance with one or more aspects of the present disclosure.

FIG. 4 shows an example of a wireless communications system that supports SSB and remaining SI multiplexing patterns in accordance with one or more aspects of the present disclosure.

FIG. 5 shows an example of an SS and SSB resource diagram that supports SSB and remaining SI multiplexing patterns in accordance with one or more aspects of the present disclosure.

FIG. 6 shows an example of an SS and physical broadcast channel resource diagram that supports SSB and remaining SI multiplexing patterns in accordance with one or more aspects of the present disclosure.

FIG. 7 shows an example of a process flow that supports SSB and remaining SI multiplexing patterns in accordance with one or more aspects of the present disclosure.

FIGS. 8 and 9 show block diagrams of devices that support SSB and remaining SI multiplexing patterns in accordance with one or more aspects of the present disclosure.

FIG. 10 shows a block diagram of a communications manager that supports SSB and remaining SI multiplexing patterns in accordance with one or more aspects of the present disclosure.

FIG. 11 shows a diagram of a system including a device that supports SSB and remaining SI multiplexing patterns in accordance with one or more aspects of the present disclosure.

FIGS. 12 and 13 show block diagrams of devices that support SSB and remaining SI multiplexing patterns in accordance with one or more aspects of the present disclosure.

FIG. 14 shows a block diagram of a communications manager that supports SSB and remaining SI multiplexing patterns in accordance with one or more aspects of the present disclosure.

FIG. 15 shows a diagram of a system including a device that supports SSB and remaining SI multiplexing patterns in accordance with one or more aspects of the present disclosure.

FIGS. 16 and 17 show flowcharts illustrating methods that support SSB and remaining SI multiplexing patterns in accordance with one or more aspects of the present disclosure.

### DETAILED DESCRIPTION

In wireless communications systems, a user equipment (UE) may monitor for synchronization signal blocks (SSBs) from a cell as a part of an initial cell search. A cell may transmit SSBs via multiple beams (e.g., may perform beam sweeping of SSBs), and the UE may measure the SSBs to select a cell and beam to access based on the measurements of the SSBs. An SSB may be transmitted over 4 symbols. An SSB may include a primary synchronization signal (PSS) in a first symbol, a physical broadcast channel (PBCH) transmitted over the subsequent three symbols, and a secondary synchronization signal (SSS) multiplexed with the PBCH transmission on the third symbol. The PSS and the SSS together may indicate the cell ID (e.g., the physical cell identifier (PCI)) of the cell that transmitted the SSB. The UE also may use the PSS and SSS to synchronize timing with the cell and to decode the PBCH transmission. The PBCH transmission may convey a master information block (MIB) which may include system information (SI) for the cell and may include scheduling information for a physical downlink control channel (PDCCH) occasion for the UE to monitor.

The PDCCH transmission in the indicated PDCCH occasion may include scheduling information for a physical downlink shared channel (PDSCH) transmission that includes SI in addition to the MIB (e.g., a system information block 1 (SIB1)) for the cell. The UE may use the SSB and the SI on the PDSCH transmission to perform initial access with the cell. Both the PDCCH and the PDSCH may be conveyed over two symbols. Frequent SSB transmissions may involve high network energy usage. Reducing the amount of SSBs transmitted in order to reduce energy usage at the network, however, may increase initial access latency and/or may reduce timing synchronization with the cell. In some examples, to reduce SSB overhead while maintaining cell presence detection latency, the PSS may be transmitted more frequently than the SSS and/or the PBCH transmission, and a UE may use the PSS to decode the SSS and/or PBCH transmission even though the SSS and/or PBCH transmissions are received later in time in disjoint symbols. In such examples, however, there are fewer (e.g., 2 or three symbols) for multiplexing the 4 symbols of the PDCCH transmission and the PDSCH transmission which carry additional SI for cell access.

Aspects of this disclosure relate to techniques for multiplexing the PDCCH transmission and the PDSCH transmission which convey additional SI with the associated PSS, SSS, and PBCH transmission, where at least the PSS is disjoint from the corresponding PBCH transmission. For example, the PSS may be disjoint from the PBCH transmission, and the PDSCH transmission may be received during the same symbols as the PBCH transmission and/or the SSS. In some examples, at least a portion of the PDCCH transmission may be received during a same symbol as the PSS. For example, in the case where the PSS is transmitted in a first symbol, and a three symbol SSB including the SSS and the PBCH transmission is transmitted during a second set of symbols disjoint from the first symbol, a first part of the PDCCH transmission may be transmitted during the same symbol as the PSS and a second part of the PDCCH transmission may be transmitted during the first symbol of the three symbol SSB. In such examples, the MIB in the PBCH transmission may indicate that the PDCCH transmission is transmitted in the two disjoint symbols, and accordingly, the UE may combine buffered data from two disjoint symbols to jointly decode the PDCCH transmission. As another example, the PSS and SSS may be transmitted in a first set of symbols, and the corresponding PBCH transmission may be transmitted during a second set of symbols. The PDCCH transmission may be transmitted during the first set of symbols with the PSS and SSS, and the PDSCH transmission may be transmitted during the second set of symbols with the PBCH transmission, where the MIB indicates that the PDCCH transmission was transmitted on the first set of symbols.

Aspects of the disclosure are initially described in the context of wireless communications systems. Aspects of the disclosure are further illustrated by and described with reference to SSB resource diagrams, synchronization signal (SS) and SSB resource diagrams, SS and PBCH resource diagrams, process flows, apparatus diagrams, system diagrams, and flowcharts that relate to SSB and remaining SI multiplexing patterns.

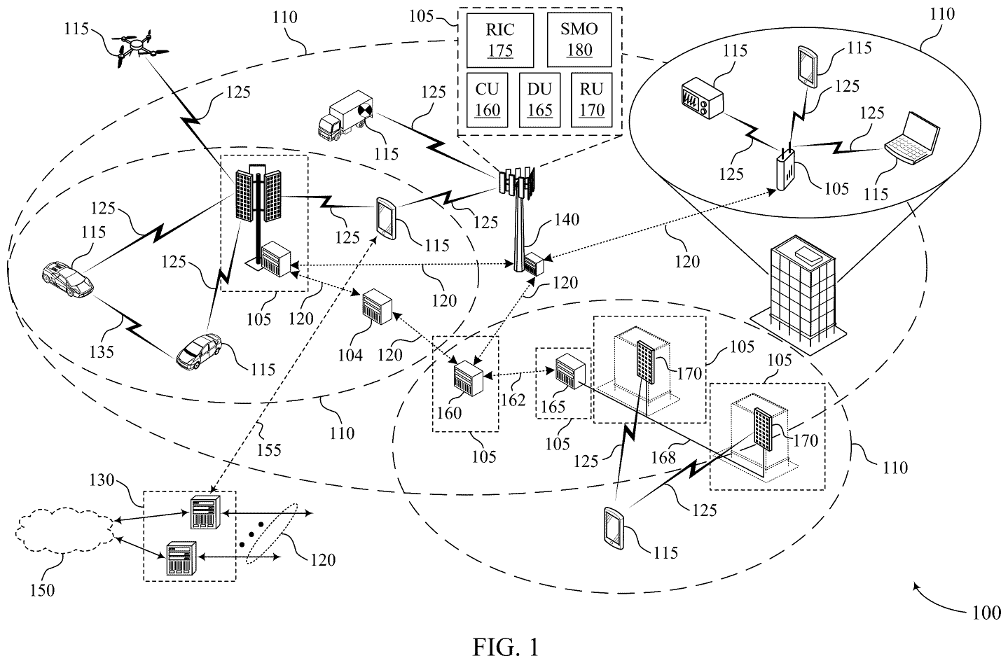

FIG. 1 shows an example of a wireless communications system 100 that supports SSB and remaining SI multiplexing patterns in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, SI), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In the wireless communications system 100, a UE 115 may monitor for SSBs from a cell (e.g., transmitted by a network entity 105) as a part of an initial cell search. The PSS and the SSS of an SSB together may indicate the cell ID (e.g., the PCI) of the cell that transmitted the SSB. The UE 115 also may use the PSS and SSS to synchronize timing with the cell and to decode the PBCH transmission of the SSB. The PBCH transmission may convey MIB which may include SI for the cell and may include scheduling information for a PDCCH occasion for the UE 115 to monitor. The PDCCH transmission in the indicated PDCCH occasion may include scheduling information for a PDSCH transmission that includes SI in addition to the MIB (e.g., a SIB1) for the cell. The UE may use the SSB and the SI on the PDSCH transmission to perform initial access with the cell. Both the PDCCH transmission and the PDSCH transmission may be conveyed over two symbols. Frequent SSB transmissions may involve high network energy usage.

Aspects of this disclosure relate to techniques for multiplexing the PDCCH transmission and the PDSCH transmission which convey additional SI with the PSS, SSS, and PBCH transmission, where at least the PSS is disjoint from the corresponding PBCH transmission. For example, the PSS may be disjoint from the PBCH transmission, and the PDSCH transmission may be received by the UE 115 during the same symbols as the PBCH transmission and/or the SSS. The disclosed techniques may allow for reduced frequency of SSB transmissions (or some components of SSBs) which may reduce energy consumption at the network without increased initial access latency. In some examples, at least a portion of the PDCCH transmission may be received during a same symbol as the PSS. For example, in the case where the PSS is transmitted in a first symbol, and a three symbol SSB including the SSS and the PBCH transmission is transmitted during a second set of symbols disjoint from the first symbol, a first part of the PDCCH transmission may be transmitted during the same symbol as the PSS and a second part of the PDCCH may be transmitted during the first symbol of the three symbol SSB (e.g., within the second set of symbols). In such examples, the MIB in the PBCH transmission may indicate that the PDCCH transmission is transmitted in the two disjoint symbols, and accordingly, the UE may combine buffered data from two disjoint symbols to jointly decode the PDCCH transmission. As another example, the PSS and SSS may be transmitted in a first set of symbols, and the corresponding PBCH transmission may be transmitted during a second set of symbols. The PDCCH transmission may be transmitted during the first set of symbols with the PSS and SSS, and the PDSCH transmission may be transmitted during the second set of symbols with the PBCH transmission, where the MIB indicates that the PDCCH transmission was transmitted on the first set of symbols.

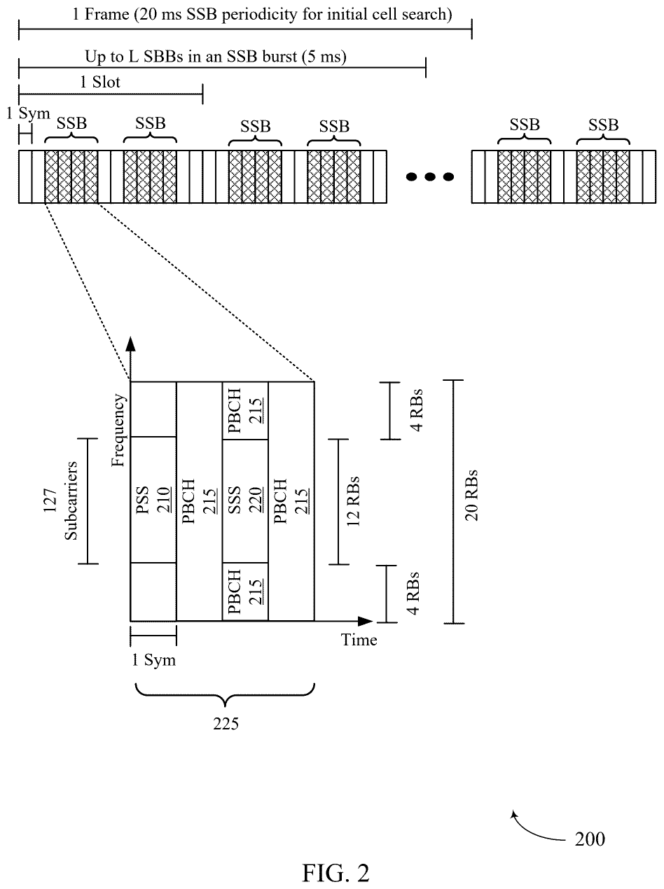

FIG. 2 shows an example of an SSB resource diagram 200 that supports SSB and remaining SI multiplexing patterns in accordance with one or more aspects of the present disclosure. The SSB resource diagram 200 may implement or may be implemented by aspects of the wireless communications system 100.

As described herein, an SSB 225 may include 4 symbols and may include a PSS 210, a PBCH transmission 215, and an SSS 220. The PSS 210 may be transmitted in a temporally first symbol of the SSB 225, the PBCH transmission 215 may be transmitted in the next three symbols of the SSB 225, and the SSS 220 may be frequency-division multiplexed with the PBCH transmission 215 on the temporally third symbol of the SSB 225. For example, the PSS 210 may be transmitted on 127 subcarriers in the temporally first symbol (e.g., 12 resource blocks (RBs)). In the temporally second symbol and the temporally fourth symbol of the SSB 225, the PBCH transmission 215 may be transmitted over 20 RBs. In the temporally third symbol of the SSB 225, the SSS 220 may be transmitted over the middle 12 RBs, and the PBCH transmission 215 may be transmitted on 4 RBs higher in frequency than the middle 12 RBs and 4 RBs lower in frequency than the middle 12 RBs. In 5G, the PSS 210 may use a length 127 frequency domain-based maximum length sequence (m-sequence) mapped to 127 subcarriers, and thus may have one of three possible sequences. The SSS 220 may use a length 127 frequency domain-based Gold Code (e.g., two m-sequences) mapped to the 127 subcarriers. Thus, the SSS 220 may have one of 1008 possible sequences. The PBCH transmission 215 may be modulated using quadrature phase shift keying (QPSK) and may be coherently demodulated using an associated demodulation reference signal (DMRS).

A cell may periodically transmit SSBs 225 via multiple beams, and the UE 115 may measure the SSBs to select a cell and beam to access. For example, the cell may transmit a burst of SSBs via multiple beams, which the UE 115 may measure to select a cell and beam. For example, as shown in the SSB resource diagram 200, a cell may transmit multiple SSBs (e.g., two as shown in FIG. 2) per slot, and may transmit up to L SSBs in an SSB burst (e.g., a 5 ms burst). A cell may periodically transmit SSB bursts, (e.g., one burst per frame (e.g., 20 ms).

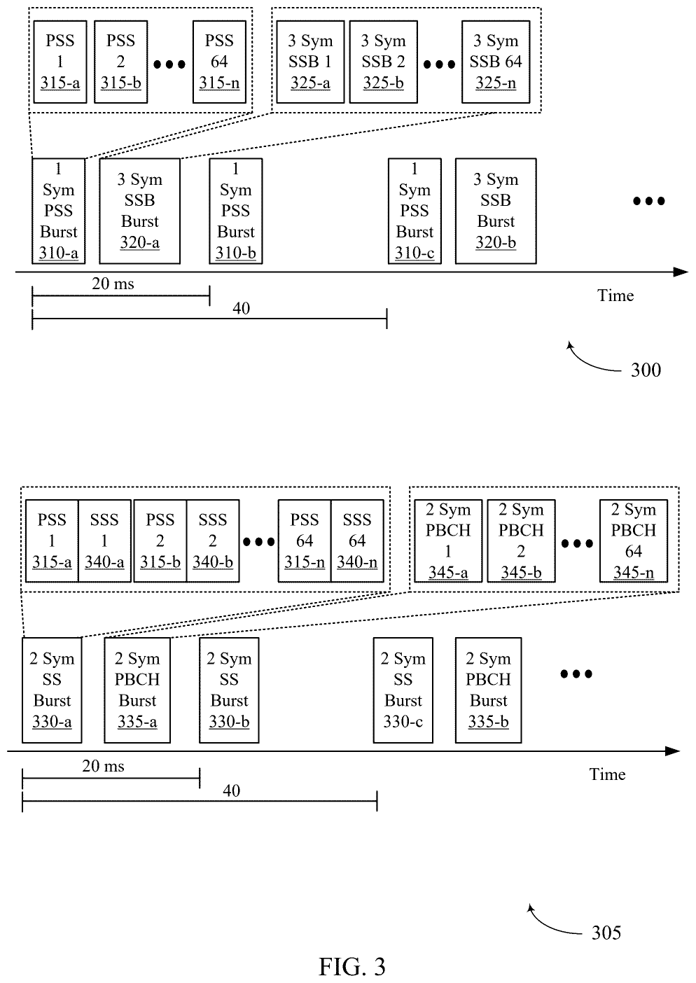

FIG. 3 shows an example SS and SSB resource diagram 300 and an example SS and SSB resource diagram 305 that support SSB and remaining SI multiplexing patterns in accordance with one or more aspects of the present disclosure. The SS and SSB resource diagram 300 and the SS and SSB resource diagram 305 may implement or may be implemented by aspects of the wireless communications system 100.

As described herein, frequent SSB transmission may be associated with high energy consumption at the network side. Less frequent SSB transmission may result in lower energy consumption at the network side but may lead to higher initial access latency for UEs 115, which may lead to performance loss and/or an inability to support low latency applications. For frequency range 2 (FR2) (e.g., frequency bands from 24.25 GHz to 71.0 GHz), to reduce SSB energy overhead while maintaining a same cell presence detection latency, a dual-burst synchronization signal approach may be used. For example, a one symbol discovery reference signal (DRS) burst may be transmitted for cell presence detection followed by an X-symbol SSB. For example, the one symbol DRS may be a one symbol PSS or a limited search hypothesis, and the X-symbol SSB may have X=3 (e.g., a one symbol cell-specific SSS and a two symbol PBCH transmission).

In a compact PSS burst approach as shown in the SS and SSB resource diagram 300, PSSs 315 (e.g., PSS sequences) may be transmitted as a PSS burst 310 without any symbol gap between the PSSs 315, for example, at a first periodicity. For example, the first periodicity may be 20 ms. For example, the PSS burst 310-a may include a set of multiple PSSs 315 (e.g., 64 PSSs 315) transmitted via a set of beams (e.g., different beams). For example, the PSS burst 310-a may include a PSS 315-a, a PSS 315-b, . . . , and a PSS 315-n. The PSSs 315 may be m-sequences mapped to 127 subcarriers, and thus each may have one of three possible sequences. A second PSS burst 310-b and a third PSS burst 310-c may repeat the PSSs 315 at the first periodicity.

SSB bursts 320 including three symbol SSBs 325 may be transmitted at a second periodicity larger than the first periodicity (e.g., the SSB bursts 320 may be transmitted at a 40 ms periodicity). For example, the SSB burst 320-b may be transmitted 40 ms after the SSB burst 320-a. By transmitting the three symbol SSBs 325 at a longer periodicity, the network may save energy as compared to transmitting four symbol SSBs at the first periodicity, but a UE 115 may still maintain synchronization with the cell using the PSSs 315 transmitted at the first periodicity. The three symbol SSBs 325 may include a PBCH transmission (e.g., two or three symbols) and an SSS (e.g., one symbol). The three symbol SSBs 325 may correspond to the PSSs 315. For example, the three symbol SSB 325-a may correspond to (e.g., may be associated with a same SSB ID or index) and may be transmitted via the same beam as the PSS 315-a, the three symbol SSB 325-b may correspond to and may be transmitted via the same beam as the PSS 315-b, and the three symbol SSB 325-n may correspond to and may be transmitted via the same beam as the PSS 315-n. Even though the three symbol SSBs 325 may be received by the UE 115 at a later time (e.g., the three symbol SSB 325-a may be disjoint in time with the PSS 315-a), the UE 115 may use information from a given PSS 315 to decode the SSS and PBCH transmission in the corresponding three symbol SSBs 325. The SSB burst 320-b may repeat the three symbol SSBs 325 at the second periodicity.

In a compact PSS and SSS burst approach (e.g., a compact SS approach) as shown in the SS and SSB resource diagram 305, the PSSs 315 and SSSs 340 may be transmitted in two symbol SS bursts at a first periodicity. For example, the first periodicity may be 20 ms. For example, the SS burst 330-a may include a set of multiple PSSs 315 (e.g., 64 PSSs 315) and consecutive corresponding SSSs 340 transmitted via a set of beams (e.g., different beams). An SS burst 330-b including the PSSs 315 and the consecutive corresponding SSs may be transmitted after the SS burst 330-a in accordance with the first periodicity (e.g., 20 ms after the SS burst 330-a). An SS burst 330-c including the PSSs 315 and the consecutive corresponding SSs may be transmitted after the SS burst 330-b in accordance with the first periodicity (e.g., 20 ms after the SS burst 330-b). The PSSs 315 may be m-sequences mapped to 127 subcarriers, and thus each may have one of three possible sequences. The SS burst 330-a may include a PSS 315-a and a corresponding SSS 340-a transmitted via a first beam, a PSS 315-b and a corresponding SSS 340-b transmitted via a second beam, . . . , and a PSS 315-n and a corresponding SSS 340-a transmitted via an nth beam.

PBCH bursts 335 including two symbol PBCH transmission 345 may be transmitted at a second periodicity larger than the first periodicity (e.g., the PBCH bursts 335 may be transmitted at a 40 ms periodicity). The two symbol PBCH transmissions 345 may correspond to the PSSs 315 and the SSSs 340. For example, in a PBCH burst 335-a, the two symbol PBCH transmissions 345-a may correspond to (e.g., may be associated with a same SSB ID or index) and may be transmitted via the same beam as the PSS 315-a and the SSS 340-a, the two symbol PBCH transmissions 345-b may correspond to and may be transmitted via the same beam as the PSS 315-b and the SSS 340-b, and the two symbol PBCH transmissions 345-n may correspond to and may be transmitted via the same beam as the PSS 315-n and the SSS 340-n. A PBCH burst 335-b may be transmitted after the PBCH burst 335-a in accordance with the second periodicity (e.g., 40 ms after the PBCH burst 335-a). Even though the two symbol PBCH transmissions 345 may be received by the UE 115 at a later time (e.g., the two symbol PBCH transmission 345-a may be disjoint in time with the PSS 315-a and the SSS 340-a), the UE 115 may use information from a given PSS 315 and SSS 340 to decode the corresponding two symbol PBCH transmission 345. By transmitting the two symbol PBCH transmissions 345 at a longer periodicity, the network may save energy as compared to transmitting four symbol SSBs at the first periodicity, but a UE 115 may still maintain synchronization with the cell using the PSSs 315 and SSSs 340 and may identify the cell (e.g., may identify the PCI) based on transmission of the PSSs 315 and SSSs 340 at the first periodicity.

In the compact PSS burst approach as shown in the SS and SSB resource diagram 300, since the PSS 315 and the rest of the three symbol SSBs 325 are transmitted separately, the PSSs 315 may be less reliable to provide timing for the SSS decoding. Thus, although the compact PSS burst approach as shown in the SS and SSB resource diagram 300 has a higher network energy savings than the compact PSS and SSS burst approach as shown in the SS and SSB resource diagram 305, the compact PSS burst approach may involve UE implementation to achieve reliable timing information. In the compact PSS and SSS burst approach as shown in the SS and SSB resource diagram 305, SSS detection and decoding may be more reliable than the compact PSS approach, but PBCH channel estimation may not be improved using the disjoint corresponding SSSs 340.

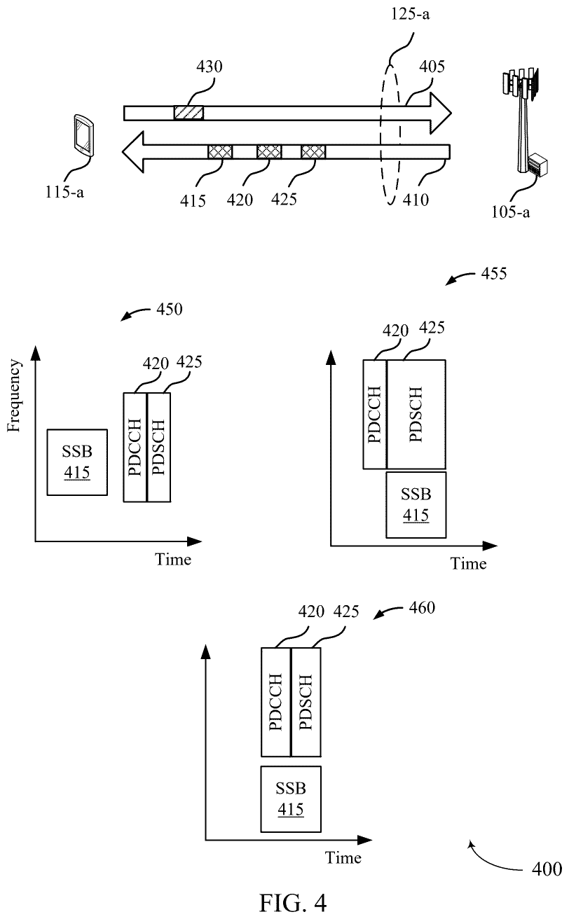

FIG. 4 shows an example of a wireless communications system 400 that supports SSB and remaining SI multiplexing patterns in accordance with one or more aspects of the present disclosure. The wireless communications system 400 may implement or may be implemented by aspects of the wireless communications system 100, the SSB resource diagram 200, the SS and SSB resource diagram 300, or the SS and SSB resource diagram 305. For example, the wireless communications system 400 includes a UE 115-a and a network entity 105-a, which may be examples of a UE 115 and a network entity 105 described with respect to FIG. 1.

The network entity 105-a may communicate with the UE 115-a via a communication link 125-a, which may be an example of an NR or LTE link between the UE 115-a and the network entity 105-a. In some cases, the communication link 125-a may include an example of an access link (e.g., a Uu link). The communication link 125-a may include a bi-directional link that enables both uplink and downlink communication. For example, the UE 115-a may transmit uplink signals 405, such as uplink control signals or uplink data signals, to the network entity 105-a using the communication link 125-a, and the network entity 105-a may transmit downlink signals 410, such as downlink control signals or downlink data signals, to the UE 115-a using the communication link 125-a.

The network entity 105-a may transmit an SSB 415. The SSB 415 may include a PSS, an SSS, and a PBCH transmission as described herein. The PSS and the SSS of the SSB 415 together may indicate the cell ID, and the UE 115-a also may use the PSS and SSS to synchronize timing with the cell and to decode the PBCH transmission of the SSB 415. The PBCH transmission may convey a MIB which may include SI for the cell and may include scheduling information for a PDCCH occasion to monitor (e.g., may indicate a control resource set (CORESET) and/or a search space to monitor for the PDCCH transmission 420). The PDCCH transmission 420 in the indicated PDCCH occasion may include scheduling information for a PDSCH transmission 425 that includes SI in addition to the MIB (e.g., a SIB1). The UE 115-a may use the SSB 415 and the SI on the PDSCH transmission 425 to perform initial access with the network entity 105-a. For example, the UE 115-a may measure multiple SSBs transmitted by the network entity, and based on the measurements may select the cell and beam associated with the SSB 415. The UE may identify a random access channel (RACH) occasion in which to transmit a RACH message 430 (e.g., a msg1 or a msgA) based on the information in the MIB and/or the information in the SIBI conveyed via the PDSCH transmission 425.

As shown in FIG. 4, multiple transmission patterns may be used for SSBs 415 and corresponding PDCCH transmissions 420 and PDSCH transmissions 425. In a first transmission pattern 450, the PDCCH transmission 420 may follow the SSB 415 (e.g., the MIB in the SSB 415 may indicate a later resource for the PDCCH). In a second transmission pattern 455, the PDCCH transmission 420 may be prior to the SSB 415 and the PDSCH transmission may be frequency division multiplexed with the SSB 415. For example, in the second transmission pattern 455, the MIB in the SSB 415 may indicate a resource for the PDCCH transmission 420 which is prior in time to the SSB 415. In a third transmission pattern 460, the PDCCH transmission 420 and the PDSCH transmission may be frequency division multiplexed with the SSB 415. For example, in the third transmission pattern 460, the MIB in the SSB 415 may indicate a resource for the PDCCH transmission 420 which is overlapping in time with the SSB 415. For example, in the second transmission pattern 455 and the third transmission pattern, the UE 115-a may monitor for the PDCCH transmission 420 and may buffer received PDCCH transmissions, and the SSB 415 may indicate a concurrent or past resource for the PDCCH transmission 420, which the UE 115-a may identify in the buffer.

With respect to the compact PSS burst approach and the compact PSS and SSS burst approach shown in FIG. 3, there may be less symbols available in the SSB burst for the second transmission pattern 455 and the third transmission pattern 460. For example, in the compact PSS burst approach, the SSB is three symbols (e.g., three symbols are available to multiplex the PDCCH transmission 420 and/or the PDSCH transmission 425) as compared to a 4 symbol SSB as described with reference to FIG. 2. As another example, in the compact PSS and SSS burst approach, the PBCH transmission has two symbols (e.g., two symbols available to multiplex the PDCCH transmission 420 and/or the PDSCH transmission 425).

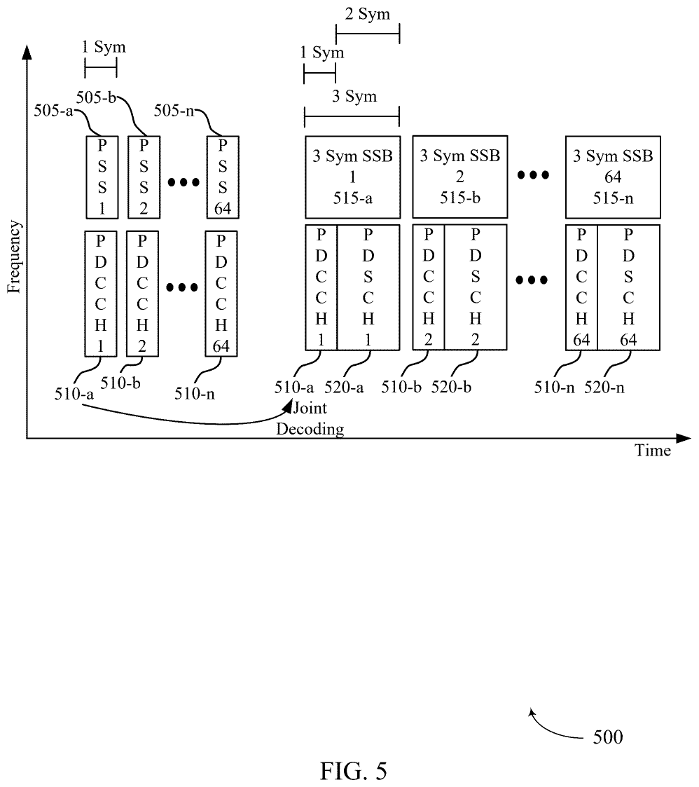

FIG. 5 shows an example of an SS and SSB resource diagram 500 that supports SSB and remaining SI multiplexing patterns in accordance with one or more aspects of the present disclosure. The SS and SSB resource diagram 500 may implement or may be implemented by aspects of the wireless communications system 100 or the wireless communications system 400.

In some examples, encoded bits of a PDCCH transmission 510 or a PDSCH for a given SSB ID (e.g., SSB index) may be carried by symbols that are disjoint in time, for example, in order to fully use symbols of both 1 symbol PSS bursts and three symbols of SSB bursts.

For example, the PDCCH transmission 510 and the PDSCH transmission 520 corresponding to a given three symbol SSB 515 (e.g., an SSB index) may each be two symbols. In some examples, as shown in FIG. 5, a first symbol of the PDCCH transmission 510 may be carried on (e.g., frequency division multiplexed on) the same symbol as the PSS 505 and a second symbol of the PDCCH transmission 510 may be carried on (e.g., frequency division multiplexed on) a symbol of the three symbol SSB 515 that corresponds to the PSS 505, where the two symbols of the PDCCH transmission 510 are disjoint in time. The UE 115 may demodulate the bits of the PDCCH transmission 510 on the two disjoint symbols and may jointly combine the demodulated bits for each PDCCH candidate. As an example, PDCCH repetition may be transmitted on the two disjoint symbols.

For example, a network entity 105 may transmit a burst of one symbol PSSs (e.g., a PSS 505-a, a PSS 505-b, . . . , and a PSS 505-n). The network entity 105 may transmit a first symbol of the PDCCH transmission 510 that corresponds to each PSS 505 on the same symbol. For example, the network entity 105 may transmit the first symbol of the PDCCH transmission 510-a frequency division multiplexed on the same symbol as the PSS 505-a. Similarly, the network entity 105 may transmit the first symbol of the PDCCH transmission 510-b frequency division multiplexed on the same symbol as the PSS 505-b, and the network entity 105 may transmit the first symbol of the PDCCH transmission 510-n frequency division multiplexed on the same symbol as the PSS 505-n.

The network entity 105 may transmit a burst of three symbol SSBs 515 that correspond to the PSSs 505 (e.g., are associated with the same SSB index and/or are transmitted via the same beam). For example, the three symbol SSBs 515 may each include a one symbol SSS and a two or three symbol PBCH transmission (e.g., in some examples, the PBCH transmission may be frequency division multiplexed on at least one symbol with the SSS).

The network entity 105 may transmit the second symbol of the PDCCH transmissions 510 frequency division multiplexed with one symbol of the corresponding three symbol SSBs 515, and/or the network entity 105 may transmit the PDSCH transmission 520 frequency division multiplexed with two symbols of the corresponding three symbol SSBs 515. For example, the second symbol of the PDCCH transmission 510-a may be multiplexed with a first symbol of the three symbol SSB 515-a, and the PDSCH transmission 520-a (which may convey a SIB1) may be frequency division multiplexed with two symbols of the three symbol SSB 515-a. The PDCCH transmission 510-a may indicate scheduling information for the PDSCH transmission 520-a. The second symbol of the PDCCH transmission 510-b may be multiplexed with a first symbol of the three symbol SSB 515-b, and the PDSCH transmission 520-b (which may convey a SIB1) may be frequency division multiplexed with two symbols of the three symbol SSB 515-b. The PDCCH transmission 510-b may indicate scheduling information for the PDSCH transmission 520-b. The second symbol of the PDCCH transmission 510-n may be multiplexed with a first symbol of the three symbol SSB 515-n, and the PDSCH transmission 520-n (which may convey remaining SI associated with the cell such as a SIB1) may be frequency division multiplexed with two symbols of the three symbol SSB 515-n. The PDCCH transmission 510-n may indicate scheduling information for the PDSCH transmission 520-n.

In some examples, as an alternative to transmission of PDCCH repetition on the two disjoint symbols, PDCCH and PDSCH may both be frequency division multiplexed on each symbol of the three symbol SSBs 515, which may involve a lower power boost for the transmission of the SSB, the PDCCH, and the PDSCH.

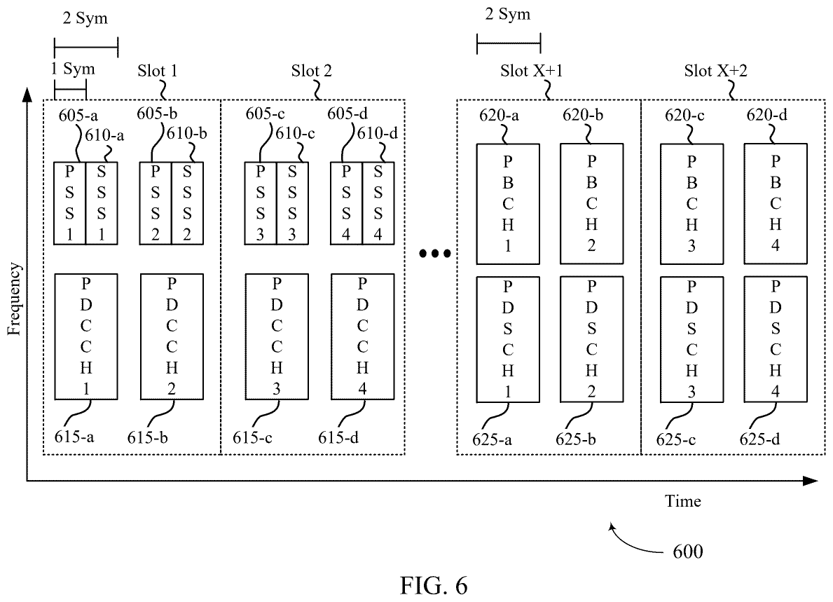

FIG. 6 shows an example of an SS and PBCH resource diagram 600 that supports SSB and remaining SI multiplexing patterns in accordance with one or more aspects of the present disclosure. The SS and PBCH resource diagram 600 may implement or may be implemented by aspects of the wireless communications system 100 or the wireless communications system 400.

In some examples, the PDCCH transmission 615 associated with a given SSB ID (e.g., SSB index) may be carried frequency division multiplexed on symbols with the PSS 605 and SSS 610 associated with the given SSB ID, for example, in the compact PSS and SSS burst approach. In such examples, the PDSCH transmission 625 associated with the given SSB ID, for which the PDCCH transmission 615 indicates scheduling information, may be frequency division multiplexed on two symbols with the corresponding PBCH transmission 620 of the SSB. Such an approach, as shown in FIG. 6 may fully use (e.g., multiplex) both the two symbol PSS and SSS burst (including the PSS 605 and the SSS 610) and the associated disjoint PBCH transmission for each given SSB ID.

For example, as shown in FIG. 6, a first SSB ID may be associated with the PSS 605-a, the SSS 610-a, and the PBCH transmission 620-a. The PSS 605-a and the SSS 610-a may each be transmitted over one symbol in a slot 1, and the symbol of the PSS 605-a may be adjacent and prior to the symbol of the SSS 610-a. The PDCCH transmission 615-a may be frequency division multiplexed with the PSS 605-a and the SSS 610-a. The PDCCH transmission 615-a may indicate scheduling information for the PDSCH transmission 625-a, which may be transmitted in slot X+1 (e.g., disjoint from the PDCCH transmission 615-a). The PDSCH transmission 625-a may be frequency division multiplexed on two symbols with the PBCH transmission 620-a. The PBCH transmission 620-a may be associated with the PSS 605-a and the SSS 610-a. For example, the PBCH transmission 620-a may be transmitted via the same beam and/or may share an SSB ID (e.g., an SSB index) with the PSS 605-a and the SSS 610-a. The PBCH transmission 620-a may include a MIB which indicates the scheduling information for the PDCCH transmission 615-a (e.g., may indicate a CORESET and/or search space), where the PDCCH transmission 615-a is prior in time to the PBCH transmission 620-a. The PDSCH transmission 625-a may include additional SI associated with the cell (e.g., remaining SI such as SIB1).

As another example, a second SSB ID may be associated with the PSS 605-b, the SSS 610-b, and the PBCH transmission 620-b. The PSS 605-b and the SSS 610-b may each be transmitted over one symbol in a slot 1, and the symbol of the PSS 605-b may be adjacent and prior to the symbol of the SSS 610-b. The PDCCH transmission 615-b may be frequency division multiplexed with the PSS 605-b and the SSS 610-b. The PDCCH transmission 615-b may indicate scheduling information for the PDSCH transmission 625-b, which may be transmitted in slot X+1 (e.g., disjoint from the PDCCH transmission 615-b). The PDSCH transmission 625-b may be frequency division multiplexed on two symbols with the PBCH transmission 620-b. The PBCH transmission 620-b may be associated with the PSS 605-b and the SSS 610-b. For example, the PBCH transmission 620-b may be transmitted via the same beam and/or may share an SSB ID (e.g., an SSB index) with the PSS 605-b and the SSS 610-b. The PBCH transmission 620-b may include a MIB which indicates the scheduling information for the PDCCH transmission 615-b (e.g., may indicate a CORESET and/or search space), where the PDCCH transmission 615-b is prior in time to the PBCH transmission 620-b. The PDSCH transmission 625-b may include additional SI associated with the cell (e.g., remaining SI such as SIB1).

As another example, a third SSB ID may be associated with the PSS 605-c, the SSS 610-c, and the PBCH transmission 620-c. The PSS 605-c and the SSS 610-c may each be transmitted over one symbol in a slot 2, and the symbol of the PSS 605-c may be adjacent and prior to the symbol of the SSS 610-c. The PDCCH transmission 615-c may be frequency division multiplexed with the PSS 605-c and the SSS 610-c. The PDCCH transmission 615-c may indicate scheduling information for the PDSCH transmission 625-c, which may be transmitted in slot X+2 (e.g., disjoint from the PDCCH transmission 615-c). The PDSCH transmission 625-c may be frequency division multiplexed on two symbols with the PBCH transmission 620-c. The PBCH transmission 620-c may be associated with the PSS 605-c and the SSS 610-c. For example, the PBCH transmission 620-c may be transmitted via the same beam and/or may share an SSB ID (e.g., an SSB index) with the PSS 605-c and the SSS 610-c. The PBCH transmission 620-c may include a MIB which indicates the scheduling information for the PDCCH transmission 615-c (e.g., may indicate a CORESET and/or search space), where the PDCCH transmission 615-c is prior in time to the PBCH transmission 620-c. The PDSCH transmission 625-c may include additional SI associated with the cell (e.g., remaining SI such as SIB1).

As another example, a fourth SSB ID may be associated with the PSS 605-d, the SSS 610-d, and the PBCH transmission 620-d. The PSS 605-d and the SSS 610-d may each be transmitted over one symbol in the slot 2, and the symbol of the PSS 605-d may be adjacent and prior to the symbol of the SSS 610-d. The PDCCH transmission 615-d may be frequency division multiplexed with the PSS 605-d and the SSS 610-d. The PDCCH transmission 615-d may indicate scheduling information for the PDSCH transmission 625-d, which may be transmitted in slot X+2 (e.g., disjoint from the PDCCH transmission 615-d). The PDSCH transmission 625-d may be frequency division multiplexed on two symbols with the PBCH transmission 620-d. The PBCH transmission 620-d may be associated with the PSS 605-d and the SSS 610-d. For example, the PBCH transmission 620-d may be transmitted via the same beam and/or may share an SSB ID (e.g., an SSB index) with the PSS 605-d and the SSS 610-d. The PBCH transmission 620-d may include a MIB which indicates the scheduling information for the PDCCH transmission 615-d (e.g., may indicate a CORESET and/or search space), where the PDCCH transmission 615-d is prior in time to the PBCH transmission 620-d. The PDSCH transmission 625-d may include additional SI associated with the cell (e.g., remaining SI such as SIB1)

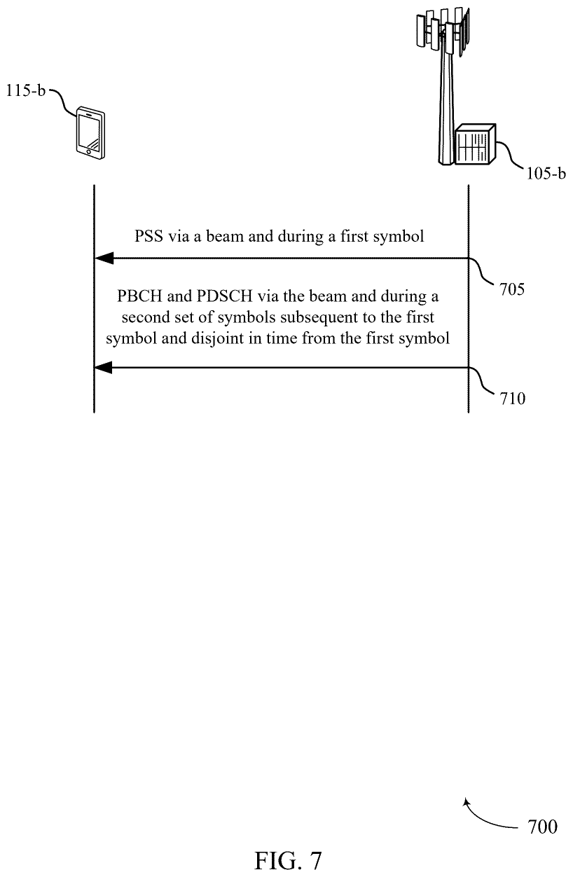

FIG. 7 shows an example of a process flow 700 that supports SSB and remaining SI multiplexing patterns in accordance with one or more aspects of the present disclosure. The process flow 700 may include a UE 115-b and a network entity 105-b, which may be examples of a UE 115 and a network entity 105 as described herein. In the following description of the process flow 700, the operations between the network entity 105-b and the UE 115-b may be transmitted in a different order than the example order shown, or the operations performed by the network entity 105-b and the UE 115-b may be performed in different orders or at different times. Some operations may also be omitted from the process flow 700, and other operations may be added to the process flow 700.

At 705, the network entity 105-b may transmit, and the UE 115-b may receive, via a beam and during a first symbol, a PSS.

At 710, the network entity 105-b may transmit, and the UE 115-b may receive, via the beam and during a second set of symbols subsequent to the first symbol, a PBCH transmission and a PDSCH transmission. The second set of symbols may be disjoint in time with the first symbol, and the PDSCH transmission may convey an SI message.

In some examples, the network entity 105-b may transmit, and the UE 115-b may receive, via the beam and during the second set of symbols, an SSS. The SSS in combination with the PSS may be indicative of a cell identifier associated with the PBCH transmission (e.g., associated with a cell of the network entity 105-b). In some examples, the network entity 105-b may transmit, and the UE 115-b may receive, via the beam and during the first symbol, a first PDCCH transmission. In such examples, the network entity 105-b may transmit, and the UE 115-b may receive, via the beam and during a second symbol, a second PDCCH transmission, where the second symbol is one of the second set of symbols, and where at least one of the first PDCCH transmission or the second PDCCH transmission indicates scheduling information for the PDSCH transmission. In some examples, the PBCH includes a MIB, and the MIB indicates that the first symbol conveys the first PDCCH transmission and the second symbol conveys the second PDCCH transmission. In some examples, the UE 115-b may jointly decode, based on the MIB, the first PDCCH transmission and the second PDCCH transmission to identify the scheduling information for the PDSCH transmission. In some examples, the network entity 105-b may transmit, and the UE 115-b may receive, via the beam and during two symbols of the second set of symbols, a PDCCH transmission that indicates scheduling information for the PDSCH transmission. In some examples, the PBCH may include a MIB, and the MIB may indicate that the two symbols convey the PDCCH transmission.

In some examples, the network entity 105-b may transmit, and the UE 115-b may receive, via the beam and during a second symbol consecutive with the first symbol, an SSS, and the SSS in combination with the PSS may be indicative of a cell identifier associated with the PBCH transmission (e.g., associated with a cell of the network entity 105-b). In some examples, the network entity 105-b may transmit, and the UE 115-b may receive, via the beam and during the first symbol and the second symbol, a PDCCH transmission that indicates scheduling information for the PDSCH transmission. In some examples: the second set of symbols includes two symbols; the PBCH transmission and the PDSCH transmission are frequency division multiplexed on the two symbols; and the PDCCH transmission is frequency division multiplexed with the PSS on the first symbol and the SSS on the second symbol. In some examples, the PBCH includes a MIB that indicates that the first symbol and the second symbol convey the PDCCH transmission.

In some examples, the network entity 105-b may transmit, and the UE 115-b may receive, a set of multiple PSSs via a set of multiple respective beams and during a set of multiple respective first symbols. The set of multiple PSSs may include the PSS, the set of multiple respective beams may include the beam, and the set of multiple respective first symbols may include the first symbol. In such examples, the network entity 105-b may transmit, and the UE 115-b may receive, a set of multiple PBCH transmissions and a set of multiple PDSCH transmissions via the set of multiple respective beams and during a set of multiple respective second sets of symbols, where the set of multiple respective second sets of symbols are disjoint in time with the set of multiple respective first symbols, and where the set of multiple PDSCH transmissions convey respective SI messages. For example, the network entity may transmit bursts of the PSSs, SSSs, and PBCH transmissions via the set of multiple beams.

In some examples, the UE 115-b may select a RACH occasion based on a measurement of the PSS, the SSS, and/or the PBCH and/or information in a MIB in the PBCH, and the PDSCH (e.g., SIB1 in a PDSCH transmission scheduled by a PDCCH transmission which is indicated by a MIB in the PBCH). For example, the UE 115-b may transmit a RACH message (e.g., a msg1 or a msgA) in the selected RACH occasion.

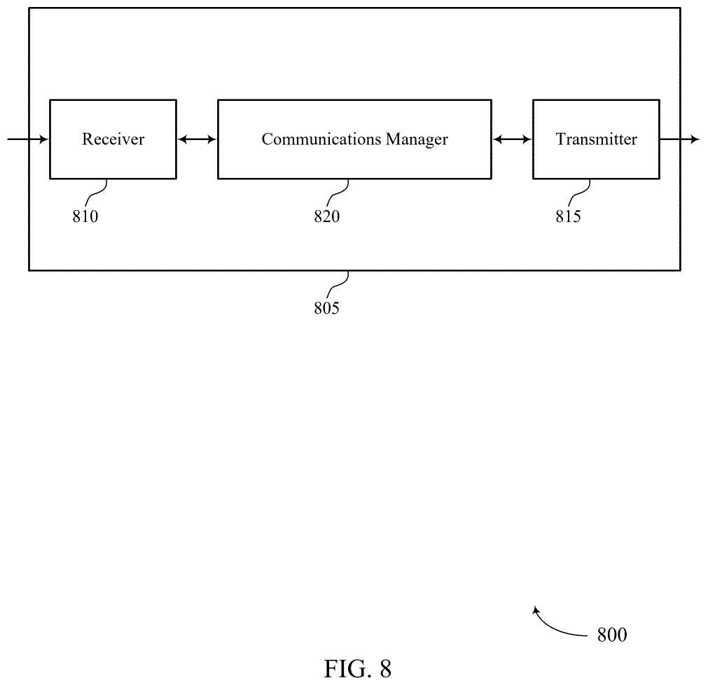

FIG. 8 shows a block diagram 800 of a device 805 that supports SSB and remaining SI multiplexing patterns in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to SSB and remaining SI multiplexing patterns). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to SSB and remaining SI multiplexing patterns). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of SSB and remaining SI multiplexing patterns as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving, via a beam and during a first symbol, a PSS. The communications manager 820 is capable of, configured to, or operable to support a means for receiving, via the beam and during a second set of symbols subsequent to the first symbol, a PBCH transmission and a PDSCH transmission, where the second set of symbols is disjoint in time with the first symbol, and where the PDSCH transmission conveys an SI message.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, and more efficient utilization of communication resources.

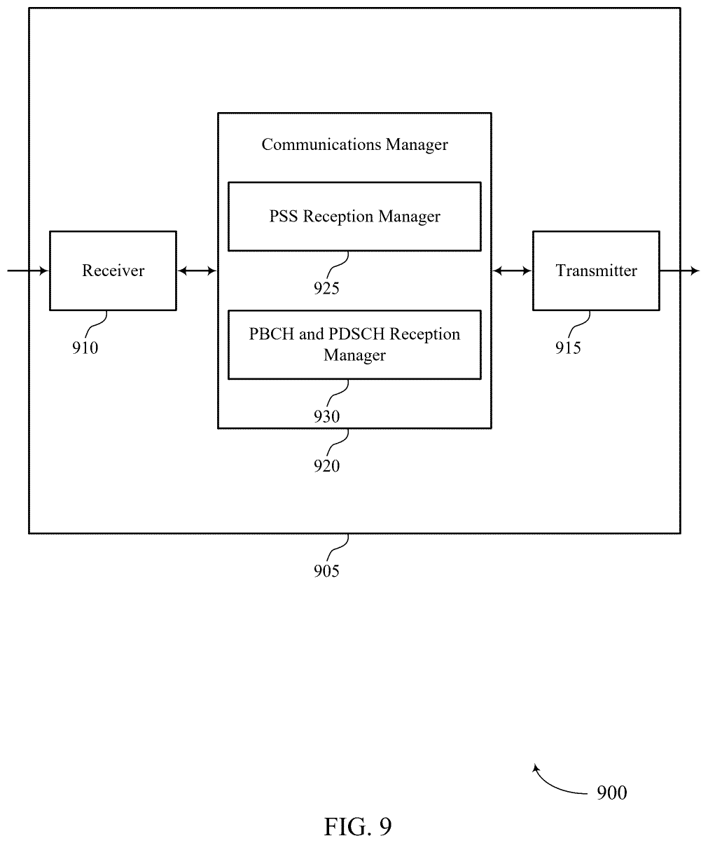

FIG. 9 shows a block diagram 900 of a device 905 that supports SSB and remaining SI multiplexing patterns in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to SSB and remaining SI multiplexing patterns). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to SSB and remaining SI multiplexing patterns). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of SSB and remaining SI multiplexing patterns as described herein. For example, the communications manager 920 may include an PSS reception manager 925 a PBCH and PDSCH reception manager 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The PSS reception manager 925 is capable of, configured to, or operable to support a means for receiving, via a beam and during a first symbol, a PSS. The PBCH and PDSCH reception manager 930 is capable of, configured to, or operable to support a means for receiving, via the beam and during a second set of symbols subsequent to the first symbol, a PBCH transmission and a PDSCH transmission, where the second set of symbols is disjoint in time with the first symbol, and where the PDSCH transmission conveys an SI message.

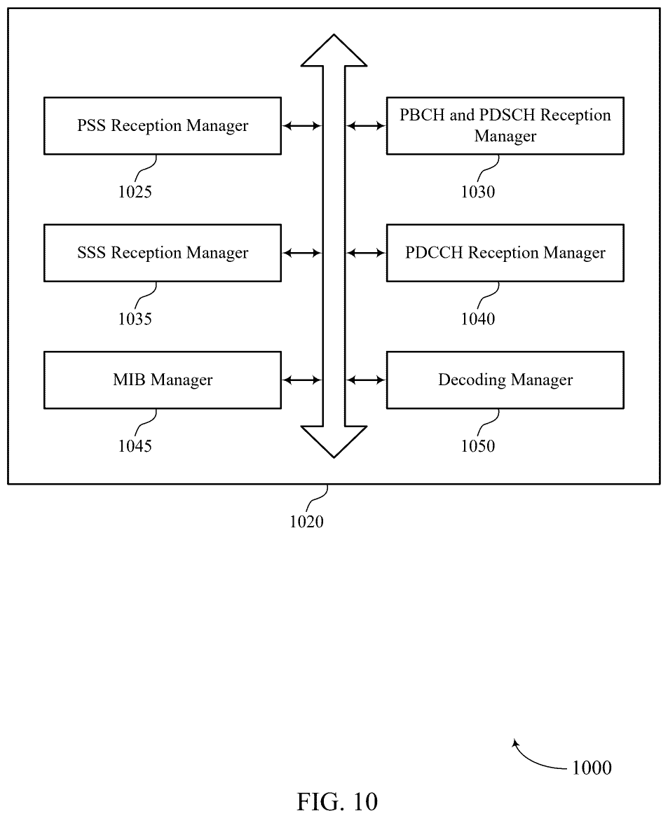

FIG. 10 shows a block diagram 1000 of a communications manager 1020 that supports SSB and remaining SI multiplexing patterns in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of SSB and remaining SI multiplexing patterns as described herein. For example, the communications manager 1020 may include an PSS reception manager 1025, a PBCH and PDSCH reception manager 1030, an SSS reception manager 1035, a PDCCH reception manager 1040, a MIB manager 1045, a decoding manager 1050, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The PSS reception manager 1025 is capable of, configured to, or operable to support a means for receiving, via a beam and during a first symbol, a PSS. The PBCH and PDSCH reception manager 1030 is capable of, configured to, or operable to support a means for receiving, via the beam and during a second set of symbols subsequent to the first symbol, a PBCH transmission and a PDSCH transmission, where the second set of symbols is disjoint in time with the first symbol, and where the PDSCH transmission conveys an SI message.

In some examples, the SSS reception manager 1035 is capable of, configured to, or operable to support a means for receiving, via the beam and during the second set of symbols, an SSS, where the SSS in combination with the PSS is indicative of a cell identifier associated with the PBCH transmission.

In some examples, the PDCCH reception manager 1040 is capable of, configured to, or operable to support a means for receiving, via the beam and during the first symbol, a first PDCCH transmission. In some examples, the PDCCH reception manager 1040 is capable of, configured to, or operable to support a means for receiving, via the beam and during a second symbol, a second PDCCH transmission, where the second symbol is one of the second set of symbols, where at least one of the first PDCCH transmission or the second PDCCH transmission indicates scheduling information for the PDSCH transmission.

In some examples, to support receiving the PBCH transmission, the MIB manager 1045 is capable of, configured to, or operable to support a means for receiving the PBCH transmission including a MIB, where the MIB indicates that the first symbol conveys the first PDCCH transmission and the second symbol conveys the second PDCCH transmission.

In some examples, the decoding manager 1050 is capable of, configured to, or operable to support a means for jointly decoding, based on the MIB, the first PDCCH transmission and the second PDCCH transmission to identify the scheduling information for the PDSCH transmission.

In some examples, the PDCCH reception manager 1040 is capable of, configured to, or operable to support a means for receiving, via the beam and during two symbols of the second set of symbols, a PDCCH transmission that indicates scheduling information for the PDSCH transmission.

In some examples, to support receiving the PBCH transmission, the MIB manager 1045 is capable of, configured to, or operable to support a means for receiving the PBCH transmission including a MIB, where the MIB indicates that the two symbols convey the PDCCH transmission.

In some examples, the SSS reception manager 1035 is capable of, configured to, or operable to support a means for receiving, via the beam and during a second symbol consecutive with the first symbol, an SSS, where the SSS in combination with the PSS is indicative of a cell identifier associated with the PBCH transmission.

In some examples, the PDCCH reception manager 1040 is capable of, configured to, or operable to support a means for receiving, via the beam and during the first symbol and the second symbol, a PDCCH transmission that indicates scheduling information for the PDSCH transmission.

In some examples, the second set of symbols includes two symbols, the PBCH transmission and the PDSCH transmission are frequency division multiplexed on the two symbols, and the PDCCH transmission is frequency division multiplexed with the PSS on the first symbol and the SSS on the second symbol.

In some examples, to support receiving the PBCH transmission, the MIB manager 1045 is capable of, configured to, or operable to support a means for receiving the PBCH transmission including a MIB, where the MIB indicates that the first symbol and the second symbol convey the PDCCH transmission.

In some examples, the PSS reception manager 1025 is capable of, configured to, or operable to support a means for receiving a set of multiple PSSs via a set of multiple respective beams and during a set of multiple respective first symbols, where the set of multiple PSSs includes the PSS, where the set of multiple respective beams includes the beam, and where the set of multiple respective first symbols includes the first symbol. In some examples, the PBCH and PDSCH reception manager 1030 is capable of, configured to, or operable to support a means for receiving a set of multiple PBCH transmissions and a set of multiple PDSCH transmissions via the set of multiple respective beams and during a set of multiple respective second sets of symbols, where the set of multiple respective second sets of symbols are disjoint in time with the set of multiple respective first symbols, and where the set of multiple PDSCH transmissions convey respective SI messages.

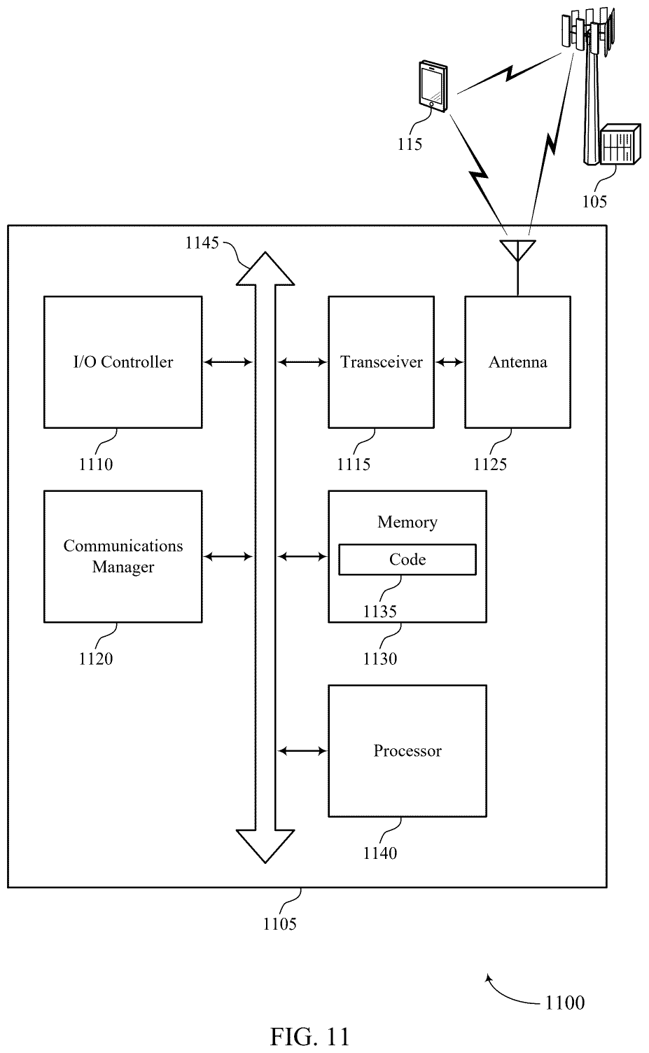

FIG. 11 shows a diagram of a system 1100 including a device 1105 that supports SSB and remaining SI multiplexing patterns in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting SSB and remaining SI multiplexing patterns). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving, via a beam and during a first symbol, a PSS. The communications manager 1120 is capable of, configured to, or operable to support a means for receiving, via the beam and during a second set of symbols subsequent to the first symbol, a PBCH transmission and a PDSCH transmission, where the second set of symbols is disjoint in time with the first symbol, and where the PDSCH transmission conveys an SI message.

By including or configuring the communications manager 1120 in accordance with examples as described herein, the device 1105 may support techniques for reduced processing, reduced power consumption, and more efficient utilization of communication resources.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of SSB and remaining SI multiplexing patterns as described herein, or the at least one processor 1140 and the at least one memory 1130 may be otherwise configured to, individually or collectively, perform or support such operations.

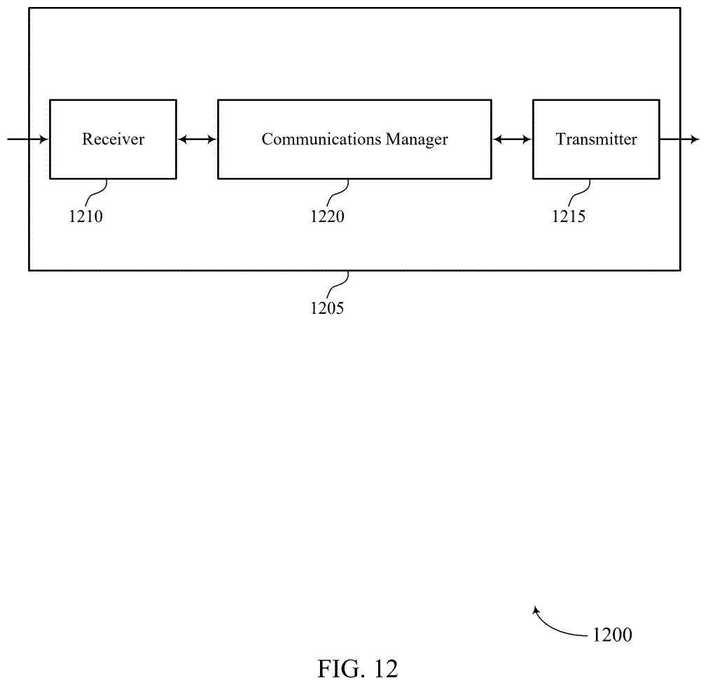

FIG. 12 shows a block diagram 1200 of a device 1205 that supports SSB and remaining SI multiplexing patterns in accordance with one or more aspects of the present disclosure. The device 1205 may be an example of aspects of a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations or components thereof may be examples of means for performing various aspects of SSB and remaining SI multiplexing patterns as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for outputting, via a beam and during a first symbol, a PSS. The communications manager 1220 is capable of, configured to, or operable to support a means for outputting, via the beam and during a second set of symbols subsequent to the first symbol, a PBCH transmission and a PDSCH transmission, where the second set of symbols is disjoint in time with the first symbol, and where the PDSCH transmission conveys an SI message.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for reduced processing, reduced power consumption, and more efficient utilization of communication resources.

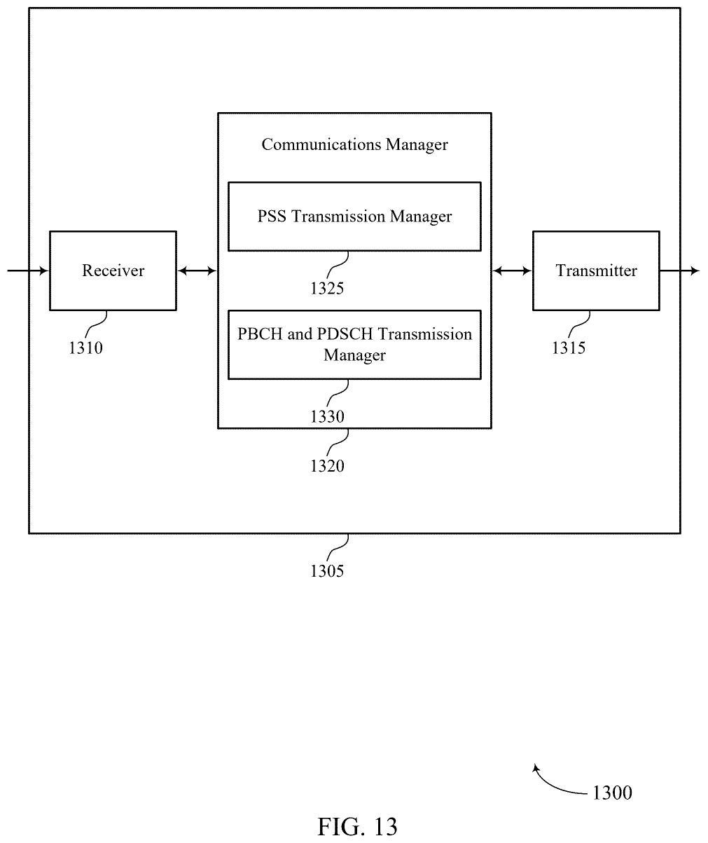

FIG. 13 shows a block diagram 1300 of a device 1305 that supports SSB and remaining SI multiplexing patterns in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of SSB and remaining SI multiplexing patterns as described herein. For example, the communications manager 1320 may include an PSS transmission manager 1325 a PBCH and PDSCH transmission manager 1330, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The PSS transmission manager 1325 is capable of, configured to, or operable to support a means for outputting, via a beam and during a first symbol, a PSS. The PBCH and PDSCH transmission manager 1330 is capable of, configured to, or operable to support a means for outputting, via the beam and during a second set of symbols subsequent to the first symbol, a PBCH transmission and a PDSCH transmission, where the second set of symbols is disjoint in time with the first symbol, and where the PDSCH transmission conveys an SI message.

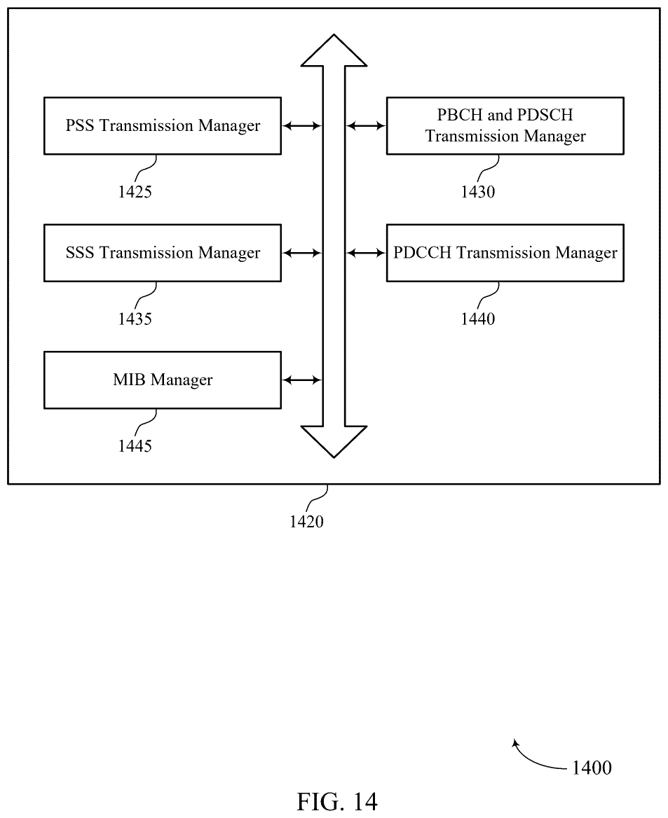

FIG. 14 shows a block diagram 1400 of a communications manager 1420 that supports SSB and remaining SI multiplexing patterns in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of SSB and remaining SI multiplexing patterns as described herein. For example, the communications manager 1420 may include an PSS transmission manager 1425, a PBCH and PDSCH transmission manager 1430, an SSS transmission manager 1435, a PDCCH transmission manager 1440, a MIB manager 1445, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications in accordance with examples as disclosed herein. The PSS transmission manager 1425 is capable of, configured to, or operable to support a means for outputting, via a beam and during a first symbol, a PSS. The PBCH and PDSCH transmission manager 1430 is capable of, configured to, or operable to support a means for outputting, via the beam and during a second set of symbols subsequent to the first symbol, a PBCH transmission and a PDSCH transmission, where the second set of symbols is disjoint in time with the first symbol, and where the PDSCH transmission conveys an SI message.

In some examples, the SSS transmission manager 1435 is capable of, configured to, or operable to support a means for outputting, via the beam and during the second set of symbols, an SSS, where the SSS in combination with the PSS is indicative of a cell identifier associated with the PBCH transmission.

In some examples, the PDCCH transmission manager 1440 is capable of, configured to, or operable to support a means for outputting, via the beam and during the first symbol, a first PDCCH transmission. In some examples, the PDCCH transmission manager 1440 is capable of, configured to, or operable to support a means for outputting, via the beam and during second symbol, a second PDCCH transmission, where the second symbol is one of the second set of symbols, where at least one of the first PDCCH transmission or the second PDCCH transmission indicates scheduling information for the PDSCH transmission.

In some examples, to support outputting the PBCH transmission, the MIB manager 1445 is capable of, configured to, or operable to support a means for outputting the PBCH transmission including a MIB, where the MIB indicates that the first symbol conveys the first PDCCH transmission and the second symbol conveys the second PDCCH transmission.

In some examples, the PDCCH transmission manager 1440 is capable of, configured to, or operable to support a means for outputting, via the beam and during two symbols of the second set of symbols, a PDCCH transmission that indicates scheduling information for the PDSCH transmission.

In some examples, to support outputting the PBCH transmission, the MIB manager 1445 is capable of, configured to, or operable to support a means for outputting the PBCH transmission including a MIB, where the MIB indicates that the two symbols convey the PDCCH transmission.

In some examples, the SSS transmission manager 1435 is capable of, configured to, or operable to support a means for outputting, via the beam and during a second symbol consecutive with the first symbol, an SSS, where the SSS in combination with the PSS is indicative of a cell identifier associated with the PBCH transmission.

In some examples, the PDCCH transmission manager 1440 is capable of, configured to, or operable to support a means for outputting, via the beam and during the first symbol and the second symbol, a PDCCH transmission that indicates scheduling information for the PDSCH transmission.

In some examples, the second set of symbols includes two symbols, the PBCH transmission and the PDSCH transmission are frequency division multiplexed on the two symbols, and the PDCCH transmission is frequency division multiplexed with the PSS on the first symbol and the SSS on the second symbol.

In some examples, to support outputting the PBCH transmission, the MIB manager 1445 is capable of, configured to, or operable to support a means for outputting the PBCH transmission including a MIB, where the MIB indicates that the first symbol and the second symbol convey the PDCCH transmission.

In some examples, the PSS transmission manager 1425 is capable of, configured to, or operable to support a means for outputting a set of multiple PSSs via a set of multiple respective beams and during a set of multiple respective first symbols, where the set of multiple PSSs includes the PSS, where the set of multiple respective beams includes the beam, and where the set of multiple respective first symbols includes the first symbol. In some examples, the PBCH and PDSCH transmission manager 1430 is capable of, configured to, or operable to support a means for outputting a set of multiple PBCH transmissions and a set of multiple PDSCH transmissions via the set of multiple respective beams and during a set of multiple respective second sets of symbols, where the set of multiple respective second sets of symbols are disjoint in time with the set of multiple respective first symbols, and where the set of multiple PDSCH transmissions convey respective SI messages.

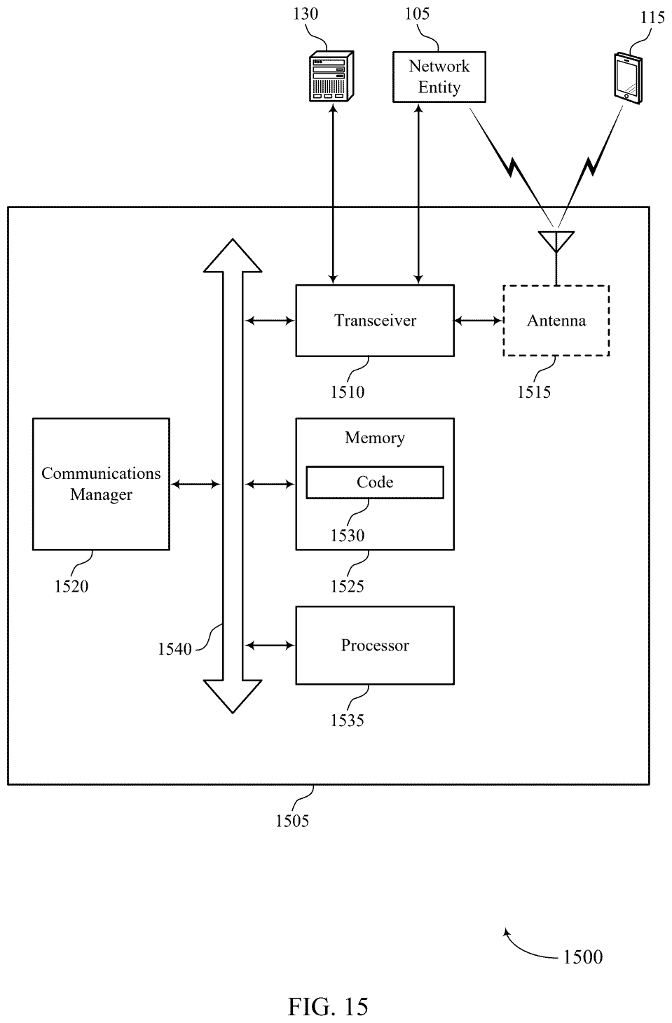

FIG. 15 shows a diagram of a system 1500 including a device 1505 that supports SSB and remaining SI multiplexing patterns in accordance with one or more aspects of the present disclosure. The device 1505 may be an example of or include components of a device 1205, a device 1305, or a network entity 105 as described herein. The device 1505 may communicate with other network devices or network equipment such as one or more of the network entities 105, UEs 115, or any combination thereof. The communications may include communications over one or more wired interfaces, over one or more wireless interfaces, or any combination thereof. The device 1505 may include components that support outputting and obtaining communications, such as a communications manager 1520, a transceiver 1510, one or more antennas 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or one or more memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., communication link(s) 125, backhaul communication link(s) 120, a midhaul communication link 162, a fronthaul communication link 168).

The at least one memory 1525 may include RAM, ROM, or any combination thereof. The at least one memory 1525 may store computer-readable, computer-executable, or processor-executable code, such as the code 1530. The code 1530 may include instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may include, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting SSB and remaining SI multiplexing patterns). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505. The at least one processor 1535 may be any one or more suitable processors capable of executing scripts or instructions of one or more software programs stored in the device 1505 (such as within one or more of the at least one memory 1525).

In some examples, the at least one processor 1535 may include multiple processors and the at least one memory 1525 may include multiple memories. One or more of the multiple processors may be coupled with one or more of the multiple memories, which may, individually or collectively, be configured to perform various functions herein. In some examples, the at least one processor 1535 may be a component of a processing system, which may refer to a system (such as a series) of machines, circuitry (including, for example, one or both of processor circuitry (which may include the at least one processor 1535) and memory circuitry (which may include the at least one memory 1525)), or components, that receives or obtains inputs and processes the inputs to produce, generate, or obtain a set of outputs. The processing system may be configured to perform one or more of the functions described herein. For example, the at least one processor 1535 or a processing system including the at least one processor 1535 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1525 or otherwise, to perform one or more of the functions described herein.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with one or more other network entities 105, and may include a controller or scheduler for controlling communications with UEs 115 (e.g., in cooperation with the one or more other network devices). In some examples, the communications manager 1520 may support an X2 interface within an LTE/LTE-A wireless communications network technology to provide communication between network entities 105.

The communications manager 1520 may support wireless communications in accordance with examples as disclosed herein. For example, the communications manager 1520 is capable of, configured to, or operable to support a means for outputting, via a beam and during a first symbol, a PSS. The communications manager 1520 is capable of, configured to, or operable to support a means for outputting, via the beam and during a second set of symbols subsequent to the first symbol, a PBCH transmission and a PDSCH transmission, where the second set of symbols is disjoint in time with the first symbol, and where the PDSCH transmission conveys an SI message.

By including or configuring the communications manager 1520 in accordance with examples as described herein, the device 1505 may support techniques for reduced processing, reduced power consumption, and more efficient utilization of communication resources.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of SSB and remaining SI multiplexing patterns as described herein, or the at least one processor 1535 and the at least one memory 1525 may be otherwise configured to, individually or collectively, perform or support such operations.

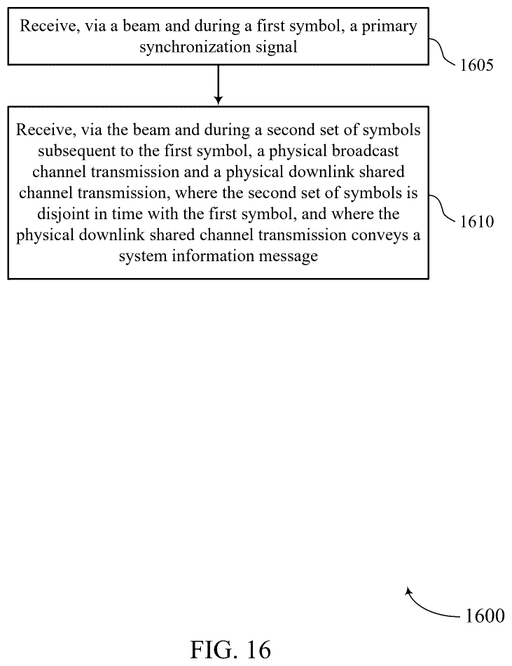

FIG. 16 shows a flowchart illustrating a method 1600 that supports SSB and remaining SI multiplexing patterns in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving, via a beam and during a first symbol, a PSS. The operations of 1605 may be performed in accordance with examples as disclosed herein. In some examples, aspects of the operations of 1605 may be performed by an PSS reception manager 1025 as described with reference to FIG. 10.

At 1610, the method may include receiving, via the beam and during a second set of symbols subsequent to the first symbol, a PBCH transmission and a PDSCH transmission, where the second set of symbols is disjoint in time with the first symbol, and where the PDSCH transmission conveys an SI message. The operations of 1610 may be performed in accordance with examples as disclosed herein. In some examples, aspects of the operations of 1610 may be performed by a PBCH and PDSCH reception manager 1030 as described with reference to FIG. 10.

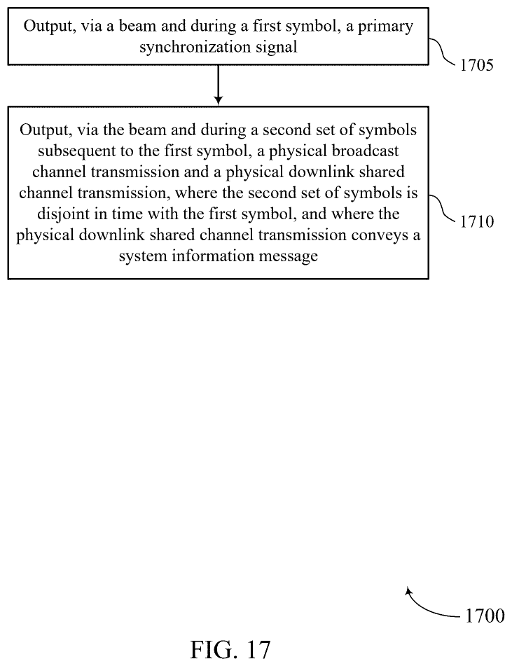

FIG. 17 shows a flowchart illustrating a method 1700 that supports SSB and remaining SI multiplexing patterns in accordance with one or more aspects of the present disclosure. The operations of the method 1700 may be implemented by a network entity or its components as described herein. For example, the operations of the method 1700 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1705, the method may include outputting, via a beam and during a first symbol, a PSS. The operations of 1705 may be performed in accordance with examples as disclosed herein. In some examples, aspects of the operations of 1705 may be performed by an PSS transmission manager 1425 as described with reference to FIG. 14.

At 1710, the method may include outputting, via the beam and during a second set of symbols subsequent to the first symbol, a PBCH transmission and a PDSCH transmission, where the second set of symbols is disjoint in time with the first symbol, and where the PDSCH transmission conveys an SI message. The operations of 1710 may be performed in accordance with examples as disclosed herein. In some examples, aspects of the operations of 1710 may be performed by a PBCH and PDSCH transmission manager 1430 as described with reference to FIG. 14.

The following provides an overview of aspects of the present disclosure:

Aspect 1: A method for wireless communications at a UE, comprising: receiving, via a beam and during a first symbol, a PSS; and receiving, via the beam and during a second set of symbols subsequent to the first symbol, a PBCH transmission and a PDSCH transmission, wherein the second set of symbols is disjoint in time with the first symbol, and wherein the PDSCH transmission conveys an SI message.

Aspect 2: The method of aspect 1, further comprising: receiving, via the beam and during the second set of symbols, an SSS, wherein the SSS in combination with the PSS is indicative of a cell identifier associated with the PBCH transmission.

Aspect 3: The method of aspect 2, further comprising: receiving, via the beam and during the first symbol, a first PDCCH transmission; and receiving, via the beam and during a second symbol, a second PDCCH transmission, wherein the second symbol is one of the second set of symbols, wherein at least one of the first PDCCH transmission or the second PDCCH transmission indicates scheduling information for the PDSCH transmission.

Aspect 4: The method of aspect 3, wherein receiving the PBCH transmission comprises: receiving the PBCH transmission including a MIB, wherein the MIB indicates that the first symbol conveys the first PDCCH transmission and the second symbol conveys the second PDCCH transmission.

Aspect 5: The method of aspect 4, further comprising: jointly decoding, based at least in part on the MIB, the first PDCCH transmission and the second PDCCH transmission to identify the scheduling information for the PDSCH transmission.

Aspect 6: The method of any of aspects 1 through 2, further comprising: receiving, via the beam and during two symbols of the second set of symbols, a PDCCH transmission that indicates scheduling information for the PDSCH transmission.

Aspect 7: The method of aspect 6, wherein receiving the PBCH transmission comprises: receiving the PBCH transmission including a MIB, wherein the MIB indicates that the two symbols convey the PDCCH transmission.

Aspect 8: The method of any of aspect 1, further comprising: receiving, via the beam and during a second symbol consecutive with the first symbol, an SSS, wherein the SSS in combination with the PSS is indicative of a cell identifier associated with the PBCH transmission.

Aspect 9: The method of aspect 8, further comprising: receiving, via the beam and during the first symbol and the second symbol, a PDCCH transmission that indicates scheduling information for the PDSCH transmission.

Aspect 10: The method of aspect 9, wherein the second set of symbols comprises two symbols, the PBCH transmission and the PDSCH transmission are frequency division multiplexed on the two symbols, and the PDCCH transmission is frequency division multiplexed with the PSS on the first symbol and the SSS on the second symbol.

Aspect 11: The method of any of aspects 9 through 10, wherein receiving the PBCH transmission comprises: receiving the PBCH transmission including a MIB, wherein the MIB indicates that the first symbol and the second symbol convey the PDCCH transmission.

Aspect 12: The method of any of aspects 1 through 11, further comprising: receiving a plurality of PSSs via a plurality of respective beams and during a plurality of respective first symbols, wherein the plurality of PSSs includes the PSS, wherein the plurality of respective beams includes the beam, and wherein the plurality of respective first symbols includes the first symbol; and receiving a plurality of PBCH transmissions and a plurality of PDSCH transmissions via the plurality of respective beams and during a plurality of respective second sets of symbols, wherein the plurality of respective second sets of symbols are disjoint in time with the plurality of respective first symbols, and wherein the plurality of PDSCH transmissions convey respective SI messages.

Aspect 13: A method for wireless communications at a network entity, comprising: outputting, via a beam and during a first symbol, a PSS; and outputting, via the beam and during a second set of symbols subsequent to the first symbol, a PBCH transmission and a PDSCH transmission, wherein the second set of symbols is disjoint in time with the first symbol, and wherein the PDSCH transmission conveys an SI message.

Aspect 14: The method of aspect 13, further comprising: outputting, via the beam and during the second set of symbols, an SSS, wherein the SSS in combination with the PSS is indicative of a cell identifier associated with the PBCH transmission.

Aspect 15: The method of aspect 14, further comprising: outputting, via the beam and during the first symbol, a first PDCCH transmission; and outputting, via the beam and during second symbol, a second PDCCH transmission, wherein the second symbol is one of the second set of symbols, wherein at least one of the first PDCCH transmission or the second PDCCH transmission indicates scheduling information for the PDSCH transmission.

Aspect 16: The method of aspect 15, wherein outputting the PBCH transmission comprises: outputting the PBCH transmission including a MIB, wherein the MIB indicates that the first symbol conveys the first PDCCH transmission and the second symbol conveys the second PDCCH transmission.

Aspect 17: The method of any of aspects 13 through 14, further comprising: outputting, via the beam and during two symbols of the second set of symbols, a PDCCH transmission that indicates scheduling information for the PDSCH transmission.

Aspect 18: The method of aspect 17, wherein outputting the PBCH transmission comprises: outputting the PBCH transmission including a MIB, wherein the MIB indicates that the two symbols convey the PDCCH transmission.

Aspect 19: The method of any of aspect 13, further comprising: outputting, via the beam and during a second symbol consecutive with the first symbol, an SSS, wherein the SSS in combination with the PSS is indicative of a cell identifier associated with the PBCH transmission.

Aspect 20: The method of aspect 19, further comprising: outputting, via the beam and during the first symbol and the second symbol, a PDCCH transmission that indicates scheduling information for the PDSCH transmission.

Aspect 21: The method of aspect 20, wherein the second set of symbols comprises two symbols, the PBCH transmission and the PDSCH transmission are frequency division multiplexed on the two symbols, and the PDCCH transmission is frequency division multiplexed with the PSS on the first symbol and the SSS on the second symbol.

Aspect 22: The method of any of aspects 20 through 21, wherein outputting the PBCH transmission comprises: outputting the PBCH transmission including a MIB, wherein the MIB indicates that the first symbol and the second symbol convey the PDCCH transmission.

Aspect 23: The method of any of aspects 13 through 22, further comprising: outputting a plurality of PSSs via a plurality of respective beams and during a plurality of respective first symbols, wherein the plurality of PSSs includes the PSS, wherein the plurality of respective beams includes the beam, and wherein the plurality of respective first symbols includes the first symbol; and outputting a plurality of PBCH transmissions and a plurality of PDSCH transmissions via the plurality of respective beams and during a plurality of respective second sets of symbols, wherein the plurality of respective second sets of symbols are disjoint in time with the plurality of respective first symbols, and wherein the plurality of PDSCH transmissions convey respective SI messages.

Aspect 24: A UE for wireless communications, comprising one or more memories storing processor-executable code, and one or more processors coupled with the one or more memories and individually or collectively operable to execute the code to cause the UE to perform a method of any of aspects 1 through 12.

Aspect 25: A UE for wireless communications, comprising at least one means for performing a method of any of aspects 1 through 12.

Aspect 26: A non-transitory computer-readable medium storing code for wireless communications, the code comprising instructions executable by one or more processors to perform a method of any of aspects 1 through 12.

Aspect 27: A network entity for wireless communications, comprising one or more memories storing processor-executable code, and one or more processors coupled with the one or more memories and individually or collectively operable to execute the code to cause the network entity to perform a method of any of aspects 13 through 23.

Aspect 28: A network entity for wireless communications, comprising at least one means for performing a method of any of aspects 13 through 23.

Aspect 29: A non-transitory computer-readable medium storing code for wireless communications, the code comprising instructions executable by one or more processors to perform a method of any of aspects 13 through 23.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, via a beam and during a first symbol, a primary synchronization signal; and
receive, via the beam and during a second set of symbols subsequent to the first symbol, a physical broadcast channel transmission and a physical downlink shared channel transmission, wherein the second set of symbols is disjoint in time with the first symbol, and wherein the physical downlink shared channel transmission conveys a system information message.

2. The UE of claim 1, wherein the one or more processors are individually or collectively further operable to execute the code to cause the UE to:
receive, via the beam and during the second set of symbols, a secondary synchronization signal, wherein the secondary synchronization signal in combination with the primary synchronization signal is indicative of a cell identifier associated with the physical broadcast channel transmission.

3. The UE of claim 2, wherein the one or more processors are individually or collectively further operable to execute the code to cause the UE to:
receive, via the beam and during the first symbol, a first physical downlink control channel transmission; and
receive, via the beam and during a second symbol, a second physical downlink control channel transmission, wherein the second symbol is one of the second set of symbols, wherein at least one of the first physical downlink control channel transmission or the second physical downlink control channel transmission indicates scheduling information for the physical downlink shared channel transmission.

4. The UE of claim 3, wherein, to receive the physical broadcast channel transmission, the one or more processors are individually or collectively operable to execute the code to cause the UE to:
receive the physical broadcast channel transmission including a master information block, wherein the master information block indicates that the first symbol conveys the first physical downlink control channel transmission and the second symbol conveys the second physical downlink control channel transmission.

5. The UE of claim 4, wherein the one or more processors are individually or collectively further operable to execute the code to cause the UE to:
jointly decode, based at least in part on the master information block, the first physical downlink control channel transmission and the second physical downlink control channel transmission to identify the scheduling information for the physical downlink shared channel transmission.

6. The UE of claim 2, wherein the one or more processors are individually or collectively further operable to execute the code to cause the UE to:
receive, via the beam and during two symbols of the second set of symbols, a physical downlink control channel transmission that indicates scheduling information for the physical downlink shared channel transmission.

7. The UE of claim 6, wherein, to receive the physical broadcast channel transmission, the one or more processors are individually or collectively operable to execute the code to cause the UE to:
receive the physical broadcast channel transmission including a master information block, wherein the master information block indicates that the two symbols convey the physical downlink control channel transmission.

8. The UE of claim 1, wherein the one or more processors are individually or collectively further operable to execute the code to cause the UE to:
receive, via the beam and during a second symbol consecutive with the first symbol, a secondary synchronization signal, wherein the secondary synchronization signal in combination with the primary synchronization signal is indicative of a cell identifier associated with the physical broadcast channel transmission.

9. The UE of claim 8, wherein the one or more processors are individually or collectively further operable to execute the code to cause the UE to:
receive, via the beam and during the first symbol and the second symbol, a physical downlink control channel transmission that indicates scheduling information for the physical downlink shared channel transmission.

10. The UE of claim 9, wherein the second set of symbols comprises two symbols, the physical broadcast channel transmission and the physical downlink shared channel transmission are frequency division multiplexed on the two symbols, and the physical downlink control channel transmission is frequency division multiplexed with the primary synchronization signal on the first symbol and the secondary synchronization signal on the second symbol.

11. The UE of claim 9, wherein, to receive the physical broadcast channel transmission, the one or more processors are individually or collectively operable to execute the code to cause the UE to:
receive the physical broadcast channel transmission including a master information block, wherein the master information block indicates that the first symbol and the second symbol convey the physical downlink control channel transmission.

12. The UE of claim 1, wherein the one or more processors are individually or collectively further operable to execute the code to cause the UE to:
receive a plurality of primary synchronization signals via a plurality of respective beams and during a plurality of respective first symbols, wherein the plurality of primary synchronization signals includes the primary synchronization signal, wherein the plurality of respective beams includes the beam, and wherein the plurality of respective first symbols includes the first symbol; and
receive a plurality of physical broadcast channel transmissions and a plurality of physical downlink shared channel transmissions via the plurality of respective beams and during a plurality of respective second sets of symbols, wherein the plurality of respective second sets of symbols are disjoint in time with the plurality of respective first symbols, and wherein the plurality of physical downlink shared channel transmissions convey respective system information messages.

13. A network entity, comprising:
one or more memories storing processor-executable code; and
one or more processors coupled with the one or more memories and individually or collectively operable to execute the code to cause the network entity to:
output, via a beam and during a first symbol, a primary synchronization signal; and
output, via the beam and during a second set of symbols subsequent to the first symbol, a physical broadcast channel transmission and a physical downlink shared channel transmission, wherein the second set of symbols is disjoint in time with the first symbol, and wherein the physical downlink shared channel transmission conveys a system information message.

14. The network entity of claim 13, wherein the one or more processors are individually or collectively further operable to execute the code to cause the network entity to:
output, via the beam and during the second set of symbols, a secondary synchronization signal, wherein the secondary synchronization signal in combination with the primary synchronization signal is indicative of a cell identifier associated with the physical broadcast channel transmission.

15. The network entity of claim 14, wherein the one or more processors are individually or collectively further operable to execute the code to cause the network entity to:
output, via the beam and during the first symbol, a first physical downlink control channel transmission; and
output, via the beam and during second symbol, a second physical downlink control channel transmission, wherein the second symbol is one of the second set of symbols, wherein at least one of the first physical downlink control channel transmission or the second physical downlink control channel transmission indicates scheduling information for the physical downlink shared channel transmission.

16. The network entity of claim 15, wherein, to output the physical broadcast channel transmission, the one or more processors are individually or collectively operable to execute the code to cause the network entity to:
output the physical broadcast channel transmission including a master information block, wherein the master information block indicates that the first symbol conveys the first physical downlink control channel transmission and the second symbol conveys the second physical downlink control channel transmission.

17. The network entity of claim 14, wherein the one or more processors are individually or collectively further operable to execute the code to cause the network entity to:
output, via the beam and during two symbols of the second set of symbols, a physical downlink control channel transmission that indicates scheduling information for the physical downlink shared channel transmission.

18. The network entity of claim 17, wherein, to output the physical broadcast channel transmission, the one or more processors are individually or collectively operable to execute the code to cause the network entity to:
output the physical broadcast channel transmission including a master information block, wherein the master information block indicates that the two symbols convey the physical downlink control channel transmission.

19. The network entity of claim 13, wherein the one or more processors are individually or collectively further operable to execute the code to cause the network entity to:
output, via the beam and during a second symbol consecutive with the first symbol, a secondary synchronization signal, wherein the secondary synchronization signal in combination with the primary synchronization signal is indicative of a cell identifier associated with the physical broadcast channel transmission.

20. The network entity of claim 19, wherein the one or more processors are individually or collectively further operable to execute the code to cause the network entity to:
output, via the beam and during the first symbol and the second symbol, a physical downlink control channel transmission that indicates scheduling information for the physical downlink shared channel transmission.

21. The network entity of claim 20, wherein the second set of symbols comprises two symbols, the physical broadcast channel transmission and the physical downlink shared channel transmission are frequency division multiplexed on the two symbols, and the physical downlink control channel transmission is frequency division multiplexed with the primary synchronization signal on the first symbol and the secondary synchronization signal on the second symbol.

22. The network entity of claim 20, wherein, to output the physical broadcast channel transmission, the one or more processors are individually or collectively operable to execute the code to cause the network entity to:
output the physical broadcast channel transmission including a master information block, wherein the master information block indicates that the first symbol and the second symbol convey the physical downlink control channel transmission.

23. The network entity of claim 13, wherein the one or more processors are individually or collectively further operable to execute the code to cause the network entity to:
output a plurality of primary synchronization signals via a plurality of respective beams and during a plurality of respective first symbols, wherein the plurality of primary synchronization signals includes the primary synchronization signal, wherein the plurality of respective beams includes the beam, and wherein the plurality of respective first symbols includes the first symbol; and
output a plurality of physical broadcast channel transmissions and a plurality of physical downlink shared channel transmissions via the plurality of respective beams and during a plurality of respective second sets of symbols, wherein the plurality of respective second sets of symbols are disjoint in time with the plurality of respective first symbols, and wherein the plurality of physical downlink shared channel transmissions convey respective system information messages.

24. A method for wireless communications at a user equipment (UE), comprising:
receiving, via a beam and during a first symbol, a primary synchronization signal; and
receiving, via the beam and during a second set of symbols subsequent to the first symbol, a physical broadcast channel transmission and a physical downlink shared channel transmission, wherein the second set of symbols is disjoint in time with the first symbol, and wherein the physical downlink shared channel transmission conveys a system information message.

25. The method of claim 24, further comprising:
receiving, via the beam and during the second set of symbols, a secondary synchronization signal, wherein the secondary synchronization signal in combination with the primary synchronization signal is indicative of a cell identifier associated with the physical broadcast channel transmission.

26. The method of claim 25, further comprising:
receiving, via the beam and during the first symbol, a first physical downlink control channel transmission; and
receiving, via the beam and during a second symbol, a second physical downlink control channel transmission, wherein the second symbol is one of the second set of symbols, wherein at least one of the first physical downlink control channel transmission or the second physical downlink control channel transmission indicates scheduling information for the physical downlink shared channel transmission.

27. The method of claim 26, wherein receiving the physical broadcast channel transmission comprises:
receiving the physical broadcast channel transmission including a master information block, wherein the master information block indicates that the first symbol conveys the first physical downlink control channel transmission and the second symbol conveys the second physical downlink control channel transmission.

28. The method of claim 27, further comprising:
jointly decoding, based at least in part on the master information block, the first physical downlink control channel transmission and the second physical downlink control channel transmission to identify the scheduling information for the physical downlink shared channel transmission.

29. The method of claim 25, further comprising:
receiving, via the beam and during two symbols of the second set of symbols, a physical downlink control channel transmission that indicates scheduling information for the physical downlink shared channel transmission.

30. A method for wireless communications at a network entity, comprising:
outputting, via a beam and during a first symbol, a primary synchronization signal; and
outputting, via the beam and during a second set of symbols subsequent to the first symbol, a physical broadcast channel transmission and a physical downlink shared channel transmission, wherein the second set of symbols is disjoint in time with the first symbol, and wherein the physical downlink shared channel transmission conveys a system information message.
